(19) United States
(12) Patent Application Publication
(10) Pub. No.: US 2016/0321403 A1
(43) Pub. Date: Nov. 3, 2016

(54) DATA COLLECTION METHOD AND APPARATUS

(71) Applicant: Huawei Technologies Co., Ltd., Shenzhen (CN)

(72) Inventors: Pinghua Wang, Shenzhen (CN); Kangmin Huang, Shenzhen (CN)

(21) Appl. No.: 15/167,083

(22) Filed: May 27, 2016

Related U.S. Application Data
(63) Continuation of application No. PCT/CN2014/076917, filed on May 7, 2014.

(30) Foreign Application Priority Data
Nov. 29, 2013 (CN) 201310628994.7

(51) Int. Cl. G06F 19/00

(52) U.S. Cl. CPC G06F 19/322; G06F 19/345

(57) ABSTRACT

Embodiments of the present invention disclose a data collection method and apparatus, which are used to adjust collection frequency intelligently. The method in the embodiments of the present invention includes the following: After acquiring vital sign data of a user, a data collection apparatus obtains a user state by means of analysis according to the vital sign data of the user; the data collection apparatus may determine different collection frequency according to different user states, and then collect vital sign data at the collection frequency; and the data collection apparatus may further analyze a user health state according to the collected vital sign data and notify the user of the user health state, and may further provide the user with health advice.

### CROSS-REFERENCE TO RELATED APPLICATIONS

This application is a continuation of International application No. PCT/CN2014/076917, filed on May 7, 2014, which claims priority to Chinese Patent Application No. 201310628994.7, filed on Nov. 29, 2013, both of which are hereby incorporated by reference in their entireties.

### TECHNICAL FIELD

The present invention relates to the field of data collection, and in particular, to a data collection method and apparatus.

### BACKGROUND

As living standards of people are improved, health care awareness of people is enhanced, and population ageing accelerates, a contradiction between people's requirement on health surveillance and insufficient medical resources is highlighted more than ever. Currently, a telemedicine service shifts from a single mode of hospital diagnosis and treatment to a combined mode in which a hospital, a community, a family, and an individual are involved, which becomes an important way to alleviate this conflict. However, in practice, it is still difficult to popularize telemedicine in a community or a family due to a core problem that a family or personal medical terminal technology develops slowly. There still exist some barriers to overcome, which are specifically as follows: A battery life of a medical terminal is insufficient to perform long-term continuous measurement, a measurement device of the medical terminal is far from small and portable and it is not comfortable to use the measurement device, and the like. In recent two years, a data collection technology is widely applied in a medical field, and a physiological information detection technology has been gradually combined with clothes and ornaments worn by people in daily life. A device integrated with a medical sensor is made into a shape of a ring, a watch, clothes, or the like, and not only can make a wearer feel convenient and comfortable, but also can detect a vital sign parameter of a user. The data collection technology can be applied to aspects such as clinical monitoring, home health care, sleep analysis, emergency medical rescue, aeronautics and astronautics, special group monitoring, mental assessment, and physical training. For example, Google Glass, Samsung Gear watch, Fitbit wristband, Jawbone bracelet, and Nike sports wristband and running shoes can track personal health and exercise, and provide functions such as data collection, health analysis, health advising, and real-time sharing.

Currently, collection frequency of a data collection apparatus is generally selected by a user or set by a machine by default, and after the collection frequency is determined, the data collection apparatus performs data collection at this frequency.

However, in an actual application, required collection frequency varies depending on a user. If the frequency is set too high, it is likely to cause high power consumption of the data collection apparatus; and if the frequency is set too low, it is likely to affect an effect of collection. Therefore, a current collection method cannot achieve a balance between power consumption and an effect.

### SUMMARY

Embodiments of the present invention provide a data collection method and apparatus, which are used to adjust collection frequency intelligently to achieve a balance between power consumption and an effect.

A first aspect of the embodiments of the present invention provides a data collection method, including:

acquiring, by a data collection apparatus, first vital sign data;

analyzing, by the data collection apparatus, a user state according to the first vital sign data;

determining, by the data collection apparatus, collection frequency according to the user state; and

collecting, by the data collection apparatus, second vital sign data at the collection frequency.

With reference to the first aspect of the embodiments of the present invention, in a first implementation manner of the first aspect of the embodiments of the present invention, the acquiring, by a data collection apparatus, first vital sign data includes:

acquiring, by the data collection apparatus, the first vital sign data by using a medical sensor in the data collection apparatus; and

the analyzing, by the data collection apparatus, a user state according to the first vital sign data specifically includes:

obtaining, by the data collection apparatus, a first deviation parameter by means of calculation according to the first vital sign data, and analyzing, by the data collection apparatus, the user state according to the first deviation parameter.

With reference to the first implementation manner of the first aspect of the embodiments of the present invention, in a second implementation manner of the first aspect of the embodiments of the present invention, the analyzing, by the data collection apparatus, the user state according to the first deviation parameter includes:

determining, by the data collection apparatus, a user state interval corresponding to the first deviation parameter;

if the first deviation parameter belongs to a first user state interval, determining that the user state is a first user state; and

if the first deviation parameter belongs to a second user state interval; determining that the user state is a second user state, where a value of a first deviation parameter in the first user state interval is less than or equal to a value of a first deviation parameter in the second user state interval.

With reference to the second implementation manner of the first aspect of the embodiments of the present invention, in a third implementation manner of the first aspect of the embodiments of the present invention, the determining, by the data collection apparatus, collection frequency according to the user state includes:

if the user state is the first user state, determining, by the data collection apparatus, that the collection frequency is first collection frequency; and

if the user state is the second user state, determining, by the data collection apparatus, that the collection frequency is second collection frequency, where the first collection frequency is less than the second collection frequency.

With reference to the first implementation manner of the first aspect or the second implementation manner of the first aspect of the embodiments of the present invention, in a fourth implementation manner of the first aspect of the embodiments of the present invention, the acquiring, by the data collection apparatus, the first vital sign data by using a medical sensor in the data collection apparatus includes:

acquiring, by the data collection apparatus, a shell temperature parameter of a user by using a temperature sensor in the medical sensor;

or,

acquiring, by the data collection apparatus, a pulse parameter of a user by using a vibration sensor in the medical sensor;

or,

acquiring, by the data collection apparatus, a blood pressure parameter of a user by using a pressure sensor in the medical sensor;

or,

acquiring, by the data collection apparatus, a respiration parameter of a user by using a flow sensor in the medical sensor;

or,

acquiring, by the data collection apparatus, a blood glucose parameter of a user by using a heat flux sensor in the medical sensor;

or,

acquiring, by the data collection apparatus, an emotion parameter of a user by using a bioelectrical sensor in the medical sensor.

With reference to the fourth implementation manner of the first aspect of the embodiments of the present invention, in a fifth implementation manner of the first aspect of the embodiments of the present invention, the method further includes:

obtaining, by the data collection apparatus, a user health state by means of analysis according to the second vital sign data.

With reference to the fifth implementation manner of the first aspect of the embodiments of the present invention, in a sixth implementation manner of the first aspect of the embodiments of the present invention, the obtaining, by the data collection apparatus, a user health state by means of analysis according to the second vital sign data includes:

dividing, by the data collection apparatus, a user health state into N health state intervals according to a preset value range of a second deviation parameter, where N is a positive integer;

obtaining, by the data collection apparatus, a second deviation parameter by means of calculation according to the second vital sign data; and

obtaining, by the data collection apparatus, the user health state by means of analysis according to the health state intervals and the second deviation parameter.

With reference to the sixth implementation manner of the first aspect of the embodiments of the present invention, in a seventh implementation manner of the first aspect of the embodiments of the present invention, the user health state includes:

a real-time user health state or a statistical user health state, where the statistical user health state is used to indicate a statistical average value of second deviation parameters that are corresponding to real-time user health states within a preset time.

With reference to the sixth implementation manner of the first aspect of the embodiments of the present invention, in an eighth implementation manner of the first aspect of the embodiments of the present invention, the method further includes:

notifying, by the data collection apparatus, the user if the user health state reaches a preset state.

With reference to the eighth implementation manner of the first aspect of the embodiments of the present invention, in a ninth implementation manner of the first aspect of the embodiments of the present invention, after the user health state is obtained by means of analysis, the method includes:

providing, by the data collection apparatus, the user with health advice according to the user health state.

With reference to the first aspect, or the first implementation manner of the first aspect, or the second implementation manner of the first aspect, or the third implementation manner of the first aspect of the embodiments of the present invention, in a tenth implementation manner of the first aspect of the embodiments of the present invention, the data collection apparatus may be a wearable data collection apparatus or an implantable data collection apparatus.

A second aspect of the embodiments of the present invention provides a data collection method, including:

acquiring, by a data collection apparatus, external state data;

determining, by the data collection apparatus, an external state according to the external state data;

acquiring, by the data collection apparatus, first vital sign data;

analyzing, by the data collection apparatus, a user state according to the external state and the first vital sign data;

determining, by the data collection apparatus, collection frequency according to the user state; and

collecting, by the data collection apparatus, second vital sign data at the collection frequency.

With reference to the second aspect of the embodiments of the present invention, in a first implementation manner of the second aspect of the embodiments of the present invention,

the external state data includes: ambient state data acquired by using an ambient perception sensor in the data collection apparatus, or activity state data acquired by using an activity perception sensor in the data collection apparatus;

the determining, by the data collection apparatus, an external state according to the external state data includes:

determining, by the data collection apparatus, an external state interval to which the external state data belongs,

if the external state data belongs to a first external state interval, determining that the external state is a first external state, and

if the external state data belongs to a second external state interval, determining that the external state is a second external state; and

the analyzing, by the data collection apparatus, a user state according to the external state and the first vital sign data includes:

obtaining, by the data collection apparatus, a first deviation parameter by means of calculation according to the external state and the first vital sign data, and

analyzing, by the data collection apparatus, the user state according to the first deviation parameter and the external state.

With reference to the first implementation manner of the second aspect of the embodiments of the present invention, in a second implementation manner of the second aspect of the embodiments of the present invention, the obtaining, by the data collection apparatus, a first deviation parameter by means of calculation according to the external state and the first vital sign data includes:

if the external state is the first external state, acquiring, by the data collection apparatus, a first normal sign range in the first external state, and obtaining a first deviation parameter in the first external state by means of calculation according to the first normal sign range and the first vital sign data; and

if the external state is the second external state, acquiring, by the data collection apparatus, a second normal sign range in the second external state, and obtaining a first deviation parameter in the second external state by means of calculation according to the second normal sign range and the first vital sign data.

With reference to the second implementation manner of the second aspect of the embodiments of the present invention, in a third implementation manner of the second aspect of the embodiments of the present invention, the analyzing, by the data collection apparatus, the user state according to the first deviation parameter and the external state includes:

if the external state is the first external state, determining, by the data collection apparatus, a user state interval corresponding to the first deviation parameter in the first external state;

if the first deviation parameter in the first external state belongs to a first user state interval, determining that the user state is a first user state;

if the first deviation parameter in the first external state belongs to a second user state interval, determining that the user state is a second user state, where a value of a first deviation parameter in the first user state interval is less than or equal to a value of a first deviation parameter in the second user state interval;

if the external state is the second external state, determining, by the data collection apparatus, a user state interval corresponding to the first deviation parameter in the second external state;

if the first deviation parameter in the second external state belongs to a third user state interval, determining that the user state is a third user state; and

if the first deviation parameter in the second external state belongs to a fourth user state interval, determining that the user state is a fourth user state, where a value of a first deviation parameter in the third user state interval is less than or equal to a value of a first deviation parameter in the fourth user state interval.

With reference to the third implementation manner of the second aspect of the embodiments of the present invention, in a fourth implementation manner of the second aspect of the embodiments of the present invention, the determining, by the data collection apparatus, collection frequency according to the user state includes:

if the user state is the first user state, determining, by the data collection apparatus, that the collection frequency is first collection frequency;

if the user state is the second user state, determining, by the data collection apparatus, that the collection frequency is second collection frequency, where the first collection frequency is less than the second collection frequency;

if the user state is the third user state, determining, by the data collection apparatus, that the collection frequency is third collection frequency; and

if the user state is the fourth user state, determining, by the data collection apparatus, that the collection frequency is fourth collection frequency, where the third collection frequency is less than the fourth collection frequency.

With reference to any one of the first to the fourth implementation manners of the second aspect of the embodiments of the present invention, in a fifth implementation manner of the second aspect of the embodiments of the present invention,

the ambient state data includes: a temperature and humidity parameter acquired by using a temperature and humidity sensor in the ambient perception sensor, an altitude acquired by using a barometric pressure sensor in the ambient perception sensor, or noise intensity acquired by using a sound sensor in the ambient perception sensor; and

the activity state data includes: an acceleration parameter acquired by using an acceleration sensor in the activity perception sensor, an orientation parameter acquired by using a gyroscope in the activity perception sensor, an action parameter acquired by using a camera in the activity perception sensor, or a time parameter acquired by using a timer in the activity perception sensor.

With reference to the fifth implementation manner of the second aspect of the embodiments of the present invention, in a sixth implementation manner of the second aspect of the embodiments of the present invention, the method further includes:

obtaining, by the data collection apparatus, a user health state by means of analysis according to the second vital sign data.

With reference to the sixth implementation manner of the second aspect of the embodiments of the present invention, in a seventh implementation manner of the second aspect of the embodiments of the present invention, the obtaining, by the data collection apparatus, a user health state by means of analysis according to the second vital sign data includes:

dividing, by the data collection apparatus, a user health state into N health state intervals according to a preset value range of a second deviation parameter, where N is a positive integer;

obtaining, by the data collection apparatus, a second deviation parameter by means of calculation according to the second vital sign data; and

obtaining, by the data collection apparatus, the user health state by means of analysis according to the health state intervals and the second deviation parameter.

With reference to the seventh implementation manner of the second aspect of the embodiments of the present invention, in an eighth implementation manner of the second aspect of the embodiments of the present invention, the user health state includes:

a real-time user health state or a statistical user health state, where the statistical user health state is used to indicate a statistical average value of second deviation parameters that are corresponding to real-time user health states within a preset time.

With reference to the eighth implementation manner of the second aspect of the embodiments of the present invention, in a ninth implementation manner of the second aspect of the embodiments of the present invention, the method further includes:

notifying, by the data collection apparatus, a user if the user health state reaches a preset state.

With reference to the ninth implementation manner of the second aspect of the embodiments of the present invention, in a tenth implementation manner of the second aspect of the embodiments of the present invention, after the user health state is obtained by means of analysis, the method includes:

providing, by the data collection apparatus, the user with health advice according to the user health state.

With reference to the second aspect, or any one of the first to the fourth implementation manners of the second aspect of the embodiments of the present invention, in an eleventh implementation manner of the second aspect of the embodiments of the present invention, the data collection apparatus may be a wearable data collection apparatus or an implantable data collection apparatus.

A third aspect of the embodiments of the present invention provides a data collection apparatus, including:

an acquiring module, configured to acquire first vital sign data;

an analysis module, configured to analyze a user state according to the first vital sign data acquired by the acquiring module;

a determining module, configured to determine collection frequency according to the user state obtained by means of analysis by the analysis module; and

a collection module, configured to collect second vital sign data at the collection frequency determined by the determining module.

With reference to the third aspect of the embodiments of the present invention, in a first implementation manner of the third aspect of the embodiments of the present invention,

the acquiring module is a medical sensor; and

the analysis module specifically includes:

a first calculating unit, configured to obtain a first deviation parameter by means of calculation according to the first vital sign data acquired by the acquiring module, and

a first analysis unit, configured to analyze the user state according to the first deviation parameter obtained by means of calculation by the first calculating unit.

With reference to the first implementation manner of the third aspect of the embodiments of the present invention, in a second implementation manner of the third aspect of the embodiments of the present invention, the first analysis unit specifically includes:

an interval determining subunit, configured to determine a user state interval corresponding to the first deviation parameter obtained by means of calculation by the first calculating unit;

a first-state determining subunit, configured to: when the first deviation parameter obtained by means of calculation by the first calculating unit belongs to a first user state interval, determine that the user state is a first user state; and

a second-state determining subunit, configured to: when the first deviation parameter obtained by means of calculation by the first calculating unit belongs to a second user state interval, determine that the user state is a second user state, where a value of a first deviation parameter in the first user state interval is less than or equal to a value of a first deviation parameter in the second user state interval.

With reference to the second implementation manner of the third aspect of the embodiments of the present invention, in a third implementation manner of the third aspect of the embodiments of the present invention, the determining module specifically includes:

a first-frequency determining unit, configured to: when the first-state determining subunit determines that the user state is the first user state, determine that the collection frequency is first collection frequency; and

a second-frequency determining unit, configured to: when the second-state determining subunit determines that the user state is the second user state, determine that the collection frequency is second collection frequency, where the first collection frequency is less than the second collection frequency.

With reference to any one of the first to the third implementation manners of the third aspect of the embodiments of the present invention, in a fourth implementation manner of the third aspect of the embodiments of the present invention, the medical sensor includes:

a temperature sensor, configured to acquire a shell temperature parameter of a user;

or,

a vibration sensor, configured to acquire a pulse parameter of a user;

or,

a pressure sensor, configured to acquire a blood pressure parameter of a user;

or,

a flow sensor, configured to acquire a respiration parameter of a user;

or,

a heat flux sensor, configured to acquire a blood glucose parameter of a user;

or,

a bioelectrical sensor, configured to acquire an emotion parameter of a user.

With reference to the fourth implementation manner of the third aspect of the embodiments of the present invention, in a fifth implementation manner of the third aspect of the embodiments of the present invention, the apparatus further includes:

a health state analysis module, configured to obtain a user health state by means of analysis according to the second vital sign data collected by the collection module.

With reference to the fifth implementation manner of the third aspect of the embodiments of the present invention, in a sixth implementation manner of the third aspect of the embodiments of the present invention, the health state analysis module specifically includes:

an interval dividing unit, configured to divide a user health state into N health state intervals according to a preset value range of a second deviation parameter, where N is a positive integer;

a second calculating unit, configured to obtain a second deviation parameter by means of calculation according to the second vital sign data collected by the collection module; and

a second analysis unit, configured to obtain the user health state by means of analysis according to the health state intervals obtained by means of division by the interval dividing unit and the second deviation parameter obtained by means of calculation by the second calculating unit.

With reference to the fifth implementation manner of the third aspect of the embodiments of the present invention, in a seventh implementation manner of the third aspect of the embodiments of the present invention, the apparatus further includes:

a notifying module, configured to notify the user when the user health state obtained by means of analysis by the health state analysis module reaches a preset state.

With reference to the seventh implementation manner of the third aspect of the embodiments of the present invention, in an eighth implementation manner of the third aspect of the embodiments of the present invention, the apparatus further includes:

an advising module, configured to provide the user with health advice according to the user health state obtained by means of analysis by the health state analysis module.

A fourth aspect of the embodiments of the present invention provides a data collection apparatus, including:

an external state acquiring module, configured to acquire external state data;

an external state determining module, configured to determine an external state according to the external state data acquired by the external state acquiring module;

a first-time sign acquiring module, configured to acquire first vital sign data;

an analysis module, configured to analyze a user state according to the external state determined by the external state determining module and the first vital sign data acquired by the first-time sign acquiring module;

a determining module, configured to determine collection frequency according to the user state obtained by means of analysis by the analysis module; and

a collection module, configured to collect second vital sign data at the collection frequency determined by the determining module.

With reference to the fourth aspect of the embodiments of the present invention, in a first implementation manner of the fourth aspect of the embodiments of the present invention,

the external state acquiring module includes: an ambient perception sensor or an activity perception sensor;

the external state determining module specifically includes:

an external state interval determining unit, configured to determine an external state interval to which the external state data acquired by the external state acquiring module belongs,

a first-external-state determining unit, configured to: when the external state interval determining unit determines that the external state data belongs to a first external state interval,

determine that the external state is a first external state, and

a second-external-state determining unit, configured to: when the external state interval determining unit determines that the external state data belongs to a second external state interval, determine that the external state is a second external state; and

the analysis module specifically includes:

a first calculating unit, configured to obtain a first deviation parameter by means of calculation according to the external state determined by the external state determining module and the first vital sign data acquired by the first-time sign acquiring module, and

a first analysis unit, configured to analyze the user state according to the first deviation parameter obtained by means of calculation by the first calculating unit and the external state determined by the external state determining module.

With reference to the first implementation manner of the fourth aspect of the embodiments of the present invention, in a second implementation manner of the fourth aspect of the embodiments of the present invention, the first calculating unit specifically includes:

a first calculating subunit, configured to: when the external state determined by the external state determining module is the first external state, acquire a first normal sign range in the first external state, and obtain a first deviation parameter in the first external state by means of calculation according to the first normal sign range and the first vital sign data that is acquired by the first-time sign acquiring module; and

a second calculating subunit, configured to: when the external state determined by the external state determining module is the second external state, acquire a second normal sign range in the second external state, and obtain a first deviation parameter in the second external state by means of calculation according to the second normal sign range and the first vital sign data that is acquired by the first-time sign acquiring module.

With reference to the second implementation manner of the fourth aspect of the embodiments of the present invention, in a third implementation manner of the fourth aspect of the embodiments of the present invention, the first analysis unit specifically includes:

a first-interval determining subunit, configured to: when the external state determined by the external state determining module is the first external state, determine a user state interval corresponding to the first deviation parameter that is in the first external state and obtained by means of calculation by the first calculating subunit;

a first-user-state determining subunit, configured to: when the first deviation parameter that is in the first external state and obtained by means of calculation by the first calculating subunit belongs to a first user state interval, determine that the user state is a first user state;

a second-user-state determining subunit, configured to: when the first deviation parameter that is in the first external state and obtained by means of calculation by the first calculating subunit belongs to a second user state interval, determine that the user state is a second user state, where a value of a first deviation parameter in the first user state interval is less than or equal to a value of a first deviation parameter in the second user state interval;

a second-interval determining subunit, configured to: when the external state determined by the external state determining module is the second external state, determine a user state interval corresponding to the first deviation parameter that is in the second external state and obtained by means of calculation by the second calculating subunit;

a third-user-state determining subunit, configured to: when the first deviation parameter that is in the second external state and obtained by means of calculation by the second calculating subunit belongs to a third user state interval, determine that the user state is a third user state; and

a fourth-user-state determining subunit, configured to: when the first deviation parameter that is in the second external state and obtained by means of calculation by the second calculating subunit belongs to a fourth user state interval, determine that the user state is a fourth user state, where a value of a first deviation parameter in the third user state interval is less than or equal to a value of a first deviation parameter in the fourth user state interval.

With reference to the third implementation manner of the fourth aspect of the embodiments of the present invention, in a fourth implementation manner of the fourth aspect of the embodiments of the present invention, the determining module specifically includes:

a first-frequency determining unit, configured to: when the user state determined by the first-user-state determining subunit is the first user state, determine that the collection frequency is first collection frequency;

a second-frequency determining unit, configured to: when the user state determined by the second-user-state determining subunit is the second user state, determine that the collection frequency is second collection frequency, where the first collection frequency is less than the second collection frequency;

a third-frequency determining unit, configured to: when the user state determined by the third-user-state determining subunit is the third user state, determine that the collection frequency is third collection frequency; and

a fourth-frequency determining unit, configured to: when the user state determined by the fourth-user-state determining subunit is the fourth user state, determine that the collection frequency is fourth collection frequency, where the third collection frequency is less than the fourth collection frequency.

With reference to any one of the first to the fourth implementation manners of the fourth aspect of the embodiments of the present invention, in a fifth implementation manner of the fourth aspect of the embodiments of the present invention,

the ambient perception sensor includes:

a temperature and humidity sensor, configured to acquire a temperature and humidity parameter;

or,

a barometric pressure sensor, configured to acquire an altitude;

or,

a sound sensor, configured to acquire noise intensity; an the activity perception sensor includes:

an acceleration sensor, configured to acquire an acceleration parameter;

or,

a gyroscope, configured to acquire an orientation parameter;

or,

a camera, configured to acquire an action parameter;

or,

a timer, configured to acquire a time parameter.

With reference to the fifth implementation manner of the fourth aspect of the embodiments of the present invention, in a sixth implementation manner of the fourth aspect of the embodiments of the present invention, the apparatus further includes:

a health state analysis module, configured to obtain a user health state by means of analysis according to the second vital sign data collected by the collection module.

With reference to the sixth implementation manner of the fourth aspect of the embodiments of the present invention, in a seventh implementation manner of the fourth aspect of the embodiments of the present invention, the health state analysis module specifically includes:

an interval dividing unit, configured to divide a user health state into N health state intervals according to a preset value range of a second deviation parameter, where N is a positive integer;

a second calculating unit, configured to obtain a second deviation parameter by means of calculation according to the second vital sign data collected by the collection module; and

a second analysis unit, configured to obtain the user health state by means of analysis according to the health state intervals obtained by means of division by the interval dividing unit and the second deviation parameter obtained by means of calculation by the second calculating unit.

With reference to the seventh implementation manner of the fourth aspect of the embodiments of the present invention, in an eighth implementation manner of the fourth aspect of the embodiments of the present invention, the apparatus further includes:

a notifying module, configured to notify a user when the user health state obtained by means of analysis by the health state analysis module reaches a preset state.

With reference to the eighth implementation manner of the fourth aspect of the embodiments of the present invention, in a ninth implementation manner of the fourth aspect of the embodiments of the present invention, the apparatus further includes:

an advising module, configured to provide the user with health advice according to the user health state obtained by means of analysis by the health state analysis module.

A fifth aspect of the embodiments of the present invention provides a collection apparatus, including:

an input apparatus, an output apparatus, a processor, and a memory, where:

by invoking an operation instruction stored in the memory, the processor is configured to perform the following steps:

acquiring first vital sign data;

analyzing a user state according to the first vital sign data;

determining collection frequency according to the user state; and

collecting second vital sign data at the collection frequency.

With reference to the fifth aspect of the embodiments of the present invention, in a first implementation manner of the fifth aspect of the embodiments of the present invention, the processor is specifically configured to perform the following steps:

obtaining a first deviation parameter by means of calculation according to the first vital sign data; and

analyzing the user state according to the first deviation parameter.

With reference to the first implementation manner of the fifth aspect of the embodiments of the present invention, in a second implementation manner of the fifth aspect of the embodiments of the present invention, the processor is specifically configured to perform the following steps:

determining a user state interval corresponding to the first deviation parameter;

when the first deviation parameter belongs to a first user state interval, determining that the user state is a first user state; and

when the first deviation parameter belongs to a second user state interval, determining that the user state is a second user state, where a value of a first deviation parameter in the first user state interval is less than or equal to a value of a first deviation parameter in the second user state interval.

With reference to the second implementation manner of the fifth aspect of the embodiments of the present invention, in a third implementation manner of the fifth aspect of the embodiments of the present invention, the processor is specifically configured to perform the following steps:

when the user state is the first user state, determining that the collection frequency is first collection frequency; and

when the user state is the second user state, determining that the collection frequency is second collection frequency, where the first collection frequency is less than the second collection frequency.

With reference to the third implementation manner of the fifth aspect of the embodiments of the present invention, in a fourth implementation manner of the fifth aspect of the embodiments of the present invention, the processor is specifically configured to perform the following steps:

dividing a user health state into N health state intervals according to a preset value range of a second deviation parameter, where N is a positive integer;

obtaining a second deviation parameter by means of calculation according to the second vital sign data;

obtaining the user health state by means of analysis according to the health state intervals and the second deviation parameter;

notifying a user when the user health state reaches a preset state; and

providing the user with health advice according to the user health state.

With reference to the fifth aspect of the embodiments of the present invention, in a fifth implementation manner of the fifth aspect of the embodiments of the present invention, the processor is further configured to perform the following steps:

acquiring external state data; and

determining an external state according to the external state data.

With reference to the fifth implementation manner of the fifth aspect of the embodiments of the present invention, in a sixth implementation manner of the fifth aspect of the embodiments of the present invention, the processor is specifically configured to perform the following steps:

determining an external state interval to which the external state data belongs;

when the external state data belongs to a first external state interval, determining that the external state is a first external state;

when the external state data belongs to a second external state interval, determining that the external state is a second external state;

obtaining a first deviation parameter by means of calculation according to the external state and the first vital sign data; and

analyzing the user state according to the first deviation parameter and the external state.

With reference to the sixth implementation manner of the fifth aspect of the embodiments of the present invention, in a seventh implementation manner of the fifth aspect of the embodiments of the present invention, the processor is specifically configured to perform the following steps:

when the external state is the first external state, acquiring a first normal sign range in the first external state, and obtaining a first deviation parameter in the first external state by means of calculation according to the first normal sign range and the first vital sign data;

when the external state is the second external state, acquiring a second normal sign range in the second external state, and obtaining a first deviation parameter in the second external state by means of calculation according to the second normal sign range and the first vital sign data;

when the external state is the first external state, determining a user state interval corresponding to the first deviation parameter in the first external state;

when the first deviation parameter in the first external state belongs to a first user state interval, determining that the user state is a first user state;

when the first deviation parameter in the first external state belongs to a second user state interval, determining that the user state is a second user state, where a value of a first deviation parameter in the first user state interval is less than or equal to a value of a first deviation parameter in the second user state interval;

when the external state is the second external state, determining a user state interval corresponding to the first deviation parameter in the second external state;

when the first deviation parameter in the second external state belongs to a third user state interval, determining that the user state is a third user state;

when the first deviation parameter in the second external state belongs to a fourth user state interval, determining that the user state is a fourth user state, where a value of a first deviation parameter in the third user state interval is less than or equal to a value of a first deviation parameter in the fourth user state interval;

when the user state is the first user state, determining that the collection frequency is first collection frequency;

when the user state is the second user state, determining that the collection frequency is second collection frequency, where the first collection frequency is less than the second collection frequency;

when the user state is the third user state, determining that the collection frequency is third collection frequency; and

when the user state is the fourth user state, determining that the collection frequency is fourth collection frequency, where the third collection frequency is less than the fourth collection frequency.

It can be learned from the foregoing technical solutions that the embodiments of the present invention have the following advantages: According to the embodiments of the present invention, a data collection apparatus acquires a user state by detecting vital sign data, determines collection frequency according to the user state, and performs user data collection at the collection frequency. In this way, the collection frequency becomes an adjustable dynamic parameter and varies with the user state; the collection frequency is adjusted intelligently, which more fits in with actual use of a user; and if the user is in a good state, the collection frequency is decreased, and if the user is in a poor state, the collection frequency is increased, thereby achieving a balance between power consumption and an effect.

### BRIEF DESCRIPTION OF DRAWINGS

FIG. 1 is a schematic flowchart of a data collection method according to an embodiment of the present invention;

FIG. 2 is another schematic flowchart of a data collection method according to an embodiment of the present invention;

FIG. 3 is another schematic flowchart of a data collection method according to an embodiment of the present invention;

FIG. 4 is another schematic flowchart of a data collection method according to an embodiment of the present invention;

FIG. 5 is another schematic flowchart of a data collection method according to an embodiment of the present invention;

FIG. 6 is another schematic flowchart, of a data collection method according to an embodiment of the present invention;

FIG. 7 is another schematic flowchart of a data collection method according to an embodiment of the present invention;

FIG. 8A and FIG. 8B are another schematic flowchart of a data collection method according to an embodiment of the present invention;

FIG. 9A, FIG. 9B and FIG. 9C are another schematic flowchart of a data collection method according to an embodiment of the present invention;

FIG. 10 is a schematic structural diagram of a data collection apparatus according to an embodiment of the present invention;

FIG. 11 is another schematic structural diagram of a data collection apparatus according to an embodiment of the present invention;

FIG. 12 is another schematic structural diagram of a data collection apparatus according to an embodiment of the present invention;

FIG. 13 is another schematic structural diagram of a data collection apparatus according to an embodiment of the present invention;

FIG. 14 is another schematic structural diagram of a data collection apparatus according to an embodiment of the present invention;

FIG. 15 is another schematic structural diagram of a data collection apparatus according to an embodiment of the present invention;

FIG. 16 is another schematic structural diagram of a data collection apparatus according to an embodiment of the present invention;

FIG. 17A and FIG. 17B are another schematic structural diagram of a data collection apparatus according to an embodiment of the present invention;

FIG. 18A and FIG. 18B are another schematic structural diagram of a data collection apparatus according to an embodiment of the present invention; and

FIG. 19 is another schematic structural diagram of a data collection apparatus according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons skilled in the art based on the embodiments of the present invention without creative efforts shall fall within the protection scope of the present invention.

A data collection apparatus may directly acquire vital sign data and perform a subsequent analysis and processing operation; or may first collect external state data to obtain an external state by means of analysis, and then acquire vital sign data and perform a subsequent analysis and processing operation.

1. A data collection apparatus directly acquires vital sign data and performs a subsequent analysis and processing operation.

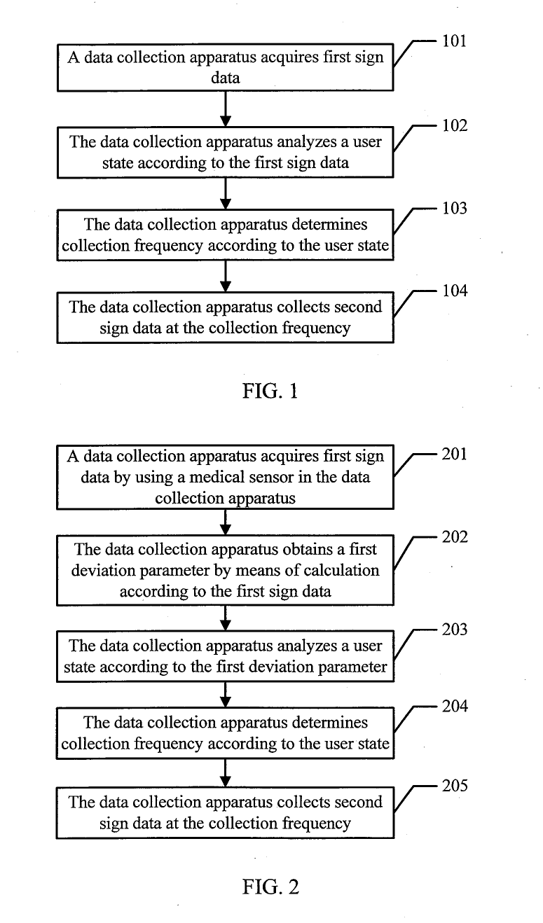

Referring to FIG. 1, an embodiment of a data collection method in the embodiments of the present invention includes:

101. A data collection apparatus acquires first vital sign data.

After starting to work, the data collection apparatus acquires the first vital sign data, where the first vital sign data is vital sign data of a user.

102. The data collection apparatus analyzes a user state according to the first vital sign data.

After acquiring the first vital sign data, the data collection apparatus analyzes the user state according to the first vital sign data.

103. The data collection apparatus determines collection frequency according to the user state.

After obtaining the user state by means of analysis, the data collection apparatus determines the collection frequency according to the user state, where the collection frequency is used to indicate a time interval between two times of collection.

104. The data collection apparatus collects second vital sign data at the collection frequency.

After determining the collection frequency, the data collection apparatus collects the second vital sign data at the collection frequency, where the second vital sign data is vital sign data of the user.

According to this embodiment of the present invention, a data collection apparatus acquires a user state by detecting vital sign data, determines collection frequency according to the user state, and performs user data collection at the collection frequency. In this way, the collection frequency becomes an adjustable dynamic parameter and varies with the user state; the collection frequency is adjusted intelligently, which more fits in with actual use of a user; and if the user is in a good state, the collection frequency is decreased, and if the user is in a poor state, the collection frequency is increased, thereby achieving a balance between power consumption and an effect.

In the foregoing embodiment, after acquiring first vital sign data, a data collection apparatus analyzes a user state according to the first vital sign data. In an actual application, the data collection apparatus may first obtain a first deviation parameter by means of calculation according to the first vital sign data, and then analyze the user state according to the first deviation parameter. The following describes a data collection method in the embodiments of the present invention. Referring to FIG. 2, another embodiment of the data collection method in the embodiments of the present invention includes:

201. A data collection apparatus acquires first vital sign data by using a medical sensor in the data collection apparatus.

After starting to work, the data collection apparatus acquires the first vital sign data by using the medical sensor in the data collection apparatus, where the first vital sign data is vital sign data of a user.

It may be understood that there are many manners for triggering the data collection apparatus to start to acquire the first vital sign data. Acquiring may be triggered by means of a physical switch, touch control, timing control, and the like; or it may be that the acquiring starts only after the user selects to activate a particular function, such as a sign monitoring function, which is not limited herein.

The first vital sign data may be single point data or may be multipoint data, which is not limited herein.

202. The data collection apparatus obtains a first deviation parameter by means of calculation according to the first vital sign data.

After acquiring the first vital sign data, the data collection apparatus obtains the first deviation parameter by means of calculation with reference to a normal sign range of healthy people.

The first deviation parameter may be a user sign deviation percentage, and a calculation formula may be

$$Sign deviation percentage \% = \vert ( \frac{2 \times {sign}_{first} - ( \begin{matrix}Health {sign}^{upper limit value} + \\ Health {sign}^{lower limit value}\end{matrix} )}{Health {sign}^{upper limit value} - Health {sign}^{lower limit value}} ) \times 100 \% \vert ;$$

or the first deviation parameter may be a difference between the first vital sign data and a health sign average value, which is not limited herein.

203. The data collection apparatus analyzes a user state according to the first deviation parameter.

After obtaining the first deviation parameter, the data collection apparatus analyzes the user state according to the first deviation parameter.

204. The data collection apparatus determines collection frequency according to the user state.

After obtaining the user state by means of analysis, the data collection apparatus determines the collection frequency according to the user state, where the collection frequency is used to indicate a time interval between two times of collection.

In an actual application, different collection frequency may be preset according to different user states, or may be set by the user, which is not limited herein.

205. The data collection apparatus collects second vital sign data at the collection frequency.

After determining the collection frequency, the data collection apparatus collects the second vital sign data at the collection frequency, where the second vital sign data is vital sign data of the user.

The second vital sign data may be collected by the medical sensor, and another sensor may participate in the collection, which is not limited herein.

In this embodiment of the present invention, a data collection apparatus first acquires first vital sign data and obtains a first deviation parameter by means of calculation according to the first vital sign data, and then analyzes a user state according to the first deviation parameter. In this way, user state analysis is more detailed, and the obtained user state is more accurate.

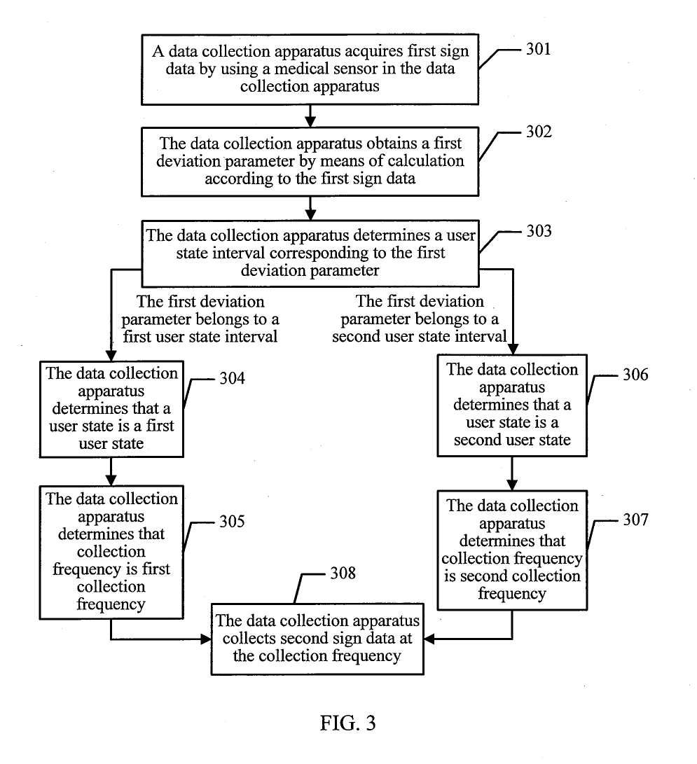

In the foregoing embodiment, after obtaining a first deviation parameter, a data collection apparatus analyzes a user state according to the first deviation parameter. In an actual application, after obtaining the first deviation parameter, the data collection apparatus may first determine a user state interval corresponding to the first deviation, and then obtain a user state indicated by the user state interval. The following describes a data collection method in the embodiments of the present invention in detail. Referring to FIG. 3, another embodiment of the data collection method in the embodiments of the present invention includes:

301. A data collection apparatus acquires first vital sign data by using a medical sensor in the data collection apparatus.

After starting to work, the data collection apparatus acquires the first vital sign data by using the medical sensor in the data collection apparatus, where the first vital sign data is vital sign data of a user.

It may be understood that there are many manners for triggering the data collection apparatus to start to acquire the first vital sign data. Acquiring may be triggered by means of a physical switch, touch control, timing control, and the like; or it may be that the acquiring starts only after the user selects to activate a particular function, such as a sign monitoring function, which is not limited herein.

The first vital sign data may be single point data or may be multipoint data, which is not limited herein.

302. The data collection apparatus obtains a first deviation parameter by means of calculation according to the first vital sign data.

After acquiring the first vital sign data, the data collection apparatus obtains the first deviation parameter by means of calculation with reference to a normal sign range of healthy people.

The first deviation parameter may be a user sign deviation percentage, and a calculation formula may

$$Sign deviation percentage \% = \vert ( \frac{2 \times {sign}_{first} - ( \begin{matrix}Health {sign}^{upperlimit value} + \\ Health {sign}^{lowerlimit value}\end{matrix} )}{Health {sign}^{upperlimit value} - Health {sign}^{lowerlimit value}} ) \times 100 \% \vert ;$$

or the first deviation parameter may be a difference between the first vital sign data and a health sign average value, which is not limited herein.

303. The data collection apparatus determines a user state interval corresponding to the first deviation parameter.

After obtaining the first deviation parameter by means of calculation, the data collection apparatus determines the user state interval corresponding to the first deviation parameter.

If it is determined that the first deviation parameter belongs to a first user state, perform step 304.

If it is determined that the first deviation parameter belongs to a second user state, perform step 306.

The data collection apparatus may divide a user state into two user state intervals according to the first deviation parameter, for example, it is specified that a range of a first deviation parameter in a first user state interval is from 0 and 50% and a corresponding user state is good, and it is specified that a range of a first deviation parameter in a second user state interval is greater than 50% and a corresponding user state is poor; or a user state may be divided into three user state intervals according to the first deviation parameter, for example, it is specified that a range of a first deviation parameter in a first user state interval is from 0 and 30% and a corresponding user state is excellent, it is specified that a first deviation parameter in a second user state interval is from 30% and 80% and a corresponding user state is medium, and it is specified that a range of a first deviation parameter in a third user state interval is greater than 80% and a corresponding user state is poor, which is not limited herein.

304. The data collection apparatus determines that a user state is a first user state.

If the data collection apparatus determines that the first deviation parameter belongs to the first user state, the data collection apparatus determines that the user state is the first user state.

305. The data collection apparatus determines that collection frequency is first collection frequency.

After determining that the user state is the first user state, the data collection apparatus determines that the collection frequency is the first collection frequency.

Collection frequency corresponding to each user state, that is, a corresponding time interval between two times of data collection, may be preset during initialization of the data collection apparatus, or may be set in a user-defined manner, which is not limited herein.

306. The data collection apparatus determines that a user state is a second user state.

If the data collection apparatus determines that the first deviation parameter belongs to the second user state, the data collection apparatus determines that the user state is the second user state.

307. The data collection apparatus determines that collection frequency is second collection frequency.

After determining that the user state is the second user state, the data collection apparatus determines that the collection frequency is the second collection frequency. If a value of a first deviation parameter in the first user state interval is less than or equal to a value of a first deviation parameter in the second user state interval, the first collection frequency is less than the second collection frequency.

It may be understood that the data collection apparatus may divide the user state into two user state intervals according to the first deviation parameter, and the two user states are corresponding to two types of collection frequency respectively; or may divide the user state into three user state intervals according to the first deviation parameter, and the three user states are corresponding to three types of collection frequency respectively, which is not limited herein.

In an actual application, the medical sensor in the data collection apparatus may include a temperature sensor that can acquire a shell temperature parameter of the user, may include a vibration sensor that can acquire a pulse parameter of the user, may include a pressure sensor that can acquire a blood pressure parameter of the user, may include a flow sensor that can acquire a respiration parameter of the user, may include a heat flux sensor that can acquire a blood glucose parameter of the user, or may include a bioelectrical sensor that can acquire an emotion parameter of the user, which is not limited herein. Parameters obtained by all types of sensors may be calculated together to obtain a first deviation parameter and obtain a comprehensive user state, where the comprehensive user state is corresponding to one type of collection frequency; or it may be that a first deviation parameter of each type of data is obtained by means of calculation to obtain a user state corresponding to each type of data, where the user state is corresponding to collection frequency of each type of sensor, which is not limited herein. As shown in Table 1 in the following, three types of sensors obtain three types of first deviation parameter, and each type of first deviation data is divided into data in three user state intervals.

TABLE 1

| | | First deviation | Collection | |
|---|---|---|---|---|
| Type | User state | parameter | frequency | |
| Blood pressure/ | Excellent | 0-30% | 12 | hours |
| Blood glucose | Medium | 30-80% | 2 | hours |
| | Poor | ≧80% | 1 | hour |
| Pulse/ | Excellent | 0-30% | 12 | hours |
| Respiration | Medium | 30-80% | 4 | hours |
| | Poor | ≧80% | 2 | hours |
| Shell | Excellent | 0-30% | 12 | hours |
| temperature/ | Medium | 30-80% | 6 | hours |
| Emotion | Poor | ≧80% | 3 | hours |

308. The data collection apparatus collects second vital sign data at the collection frequency.

After determining the collection frequency, the data collection apparatus collects the second vital sign data at the collection frequency, where the second vital sign data is vital sign data of the user.

The second vital sign data may be collected by the medical sensor, and another sensor may participant in the collection, which is not limited herein.

In this embodiment of the present invention, after obtaining a first deviation parameter, a data collection apparatus first determines a user state interval corresponding to the first deviation parameter, and then determines a user state according to the user state interval. In this way, determining of a user state is more accurate, and different user states are corresponding to different collection frequency, so that data collection of the data collection apparatus better meets a requirement of a user.

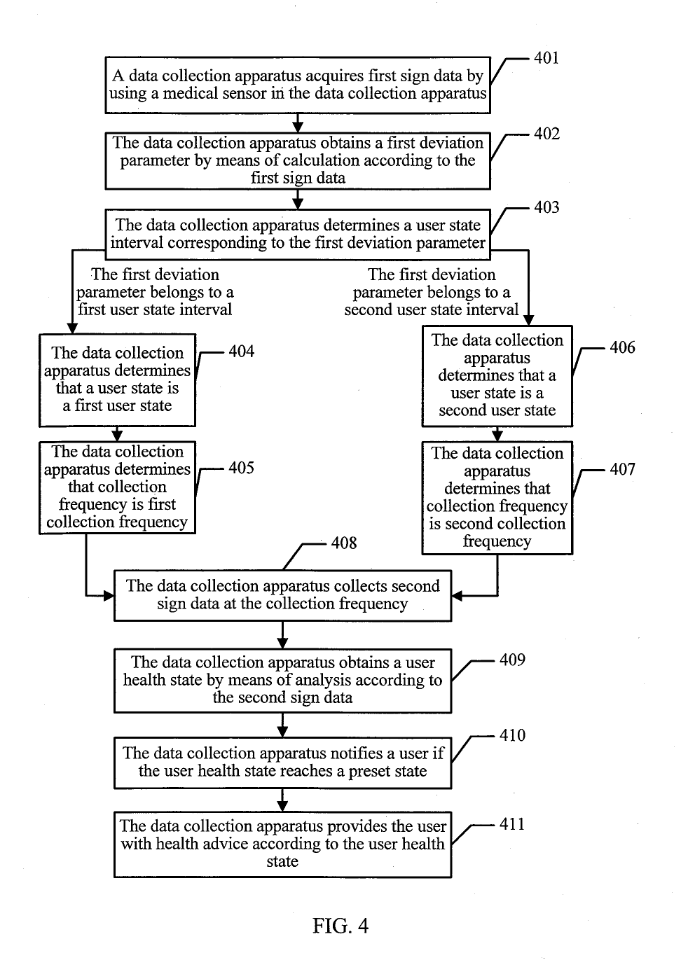

In the foregoing embodiment, after obtaining second vital sign data, a data collection apparatus may further analyze a user health state according to the second vital sign data, and perform subsequent processing according to the user health state. The following describes a data collection method in the embodiments of the present invention in detail. Referring to FIG. 4, another embodiment of the data collection method in the embodiments of the present invention includes:

401. A data collection apparatus acquires first vital sign data by using a medical sensor in the data collection apparatus.

After starting to work, the data collection apparatus acquires the first vital sign data by using the medical sensor in the data collection apparatus, where the first vital sign data is vital sign data of a user.

It may be understood that there are many manners for triggering the data collection apparatus to start to acquire the first vital sign data. Acquiring may be triggered by means of a physical switch, touch control, timing control, and the like; or it may be that the acquiring starts only after the user selects to activate a particular function, such as a sign monitoring function, which is not limited herein.

The first vital sign data may be single point data or may be multipoint data, which is not limited herein.

402. The data collection apparatus obtains a first deviation parameter by means of calculation according to the first vital sign data.

After acquiring the first vital sign data, the data collection apparatus obtains the first deviation parameter by means of calculation with reference to a normal sign range of healthy people.

The first deviation parameter may be a user sign deviation percentage, and a calculation formula may be

$$Sign deviation percentage \% = \vert ( \frac{2 \times {sign}_{first} - ( \begin{matrix}Health {sign}^{upperlimit value} + \\ Health {sign}^{lowerlimit value}\end{matrix} )}{Health {sign}^{upperlimit value} - Health {sign}^{lowerlimit value}} ) \times 100 \% \vert ;$$

or the first deviation parameter may be a difference between the first vital sign data and a health sign average value, which is not limited herein.

403. The data collection apparatus determines a user state interval corresponding to the first deviation parameter.

After obtaining the first deviation parameter by means of calculation, the data collection apparatus determines the user state interval corresponding to the first deviation parameter.

If it is determined that the first deviation parameter belongs to a first user state, perform step 404.

If it is determined that the first deviation parameter belongs to a second user state, perform step 406.

The data collection apparatus may divide a user state into two user state intervals according to the first deviation parameter, for example, it is specified that a range of a first deviation parameter in a first user state interval is from 0 and 50% and a corresponding user state is good, and it is specified that a range of a first deviation parameter in a second user state interval is greater than 50% and a corresponding user state is poor; or a user state may be divided into three user state intervals according to the first deviation parameter, for example, it is specified that a range of a first deviation parameter in a first user state interval is from 0 and 30% and a corresponding user state is excellent, it is specified that a first deviation parameter in a second user state interval is from 30% and 80% and a corresponding user state is medium, and it is specified that a range of a first deviation parameter in a third user state interval is greater than 80% and a corresponding user state is poor, which is not limited herein.

404. The data collection apparatus determines that a user state is a first user state.

If the data collection apparatus determines that the first deviation parameter belongs to the first user state, the data collection apparatus determines that the user state is the first user state.

405. The data collection apparatus determines that collection frequency is first collection frequency.

After determining that the user state is the first user state, the data collection apparatus determines that the collection frequency is the first collection frequency.

Collection frequency corresponding to each user state, that is, a corresponding time interval between two times of data collection, may be preset during initialization of the data collection apparatus, or may be set in a user-defined manner, which is not limited herein.

406. The data collection apparatus determines that a user state is a second user state.

If the data collection apparatus determines that the first deviation parameter belongs to the second user state, the data collection apparatus determines that the user state is the second user state.

407. The data collection apparatus determines that collection frequency is second collection frequency.

After determining that the user state is the second user state, the data collection apparatus determines that the collection frequency is the second collection frequency. If a value of a first deviation parameter in the first user state interval is less than or equal to a value of a first deviation parameter in the second user state interval, the first collection frequency is less than the second collection frequency.

It may be understood that the data collection apparatus may divide the user state into two user state intervals according to the first deviation parameter, and the two user states are corresponding to two types of collection frequency respectively; or may divide the user state into three user state intervals according to the first deviation parameter, and the three user states are corresponding to three types of collection frequency respectively, which is not limited herein.

In an actual application, the medical sensor in the data collection apparatus may include a temperature sensor that can acquire a shell temperature parameter of the user, may include a vibration sensor that can acquire a pulse parameter of the user, may include a pressure sensor that can acquire a blood pressure parameter of the user, may include a flow sensor that can acquire a respiration parameter of the user, may include a heat flux sensor that can acquire a blood glucose parameter of the user, or may include a bioelectrical sensor that can acquire an emotion parameter of the user, which is not limited herein. Parameters obtained by all types of sensors may be calculated together to obtain a first deviation parameter and obtain a comprehensive user state, where the comprehensive user state is corresponding to one type of collection frequency; or it may be that a first deviation parameter of each type of data is obtained by means of calculation to obtain a user state corresponding to each type of data, where the user state is corresponding to collection frequency of each type of sensor, which is not limited herein. As shown in Table 2 in the following, three types of sensors obtain three types of first deviation data, and each type of first deviation data is divided into data in three user state intervals.

TABLE 2

| | | First deviation | Collection | |
|---|---|---|---|---|
| Type | User state | parameter | frequency | |
| Blood pressure/ | Excellent | 0-30% | 12 | hours |
| Blood glucose | Medium | 30-80% | 2 | hours |
| | Poor | ≧80% | 1 | hour |
| Pulse/ | Excellent | 0-30% | 12 | hours |
| Respiration | Medium | 30-80% | 4 | hours |
| | Poor | ≧80% | 2 | hours |
| Shell | Excellent | 0-30% | 12 | hours |
| temperature/ | Medium | 30-80% | 6 | hours |
| Emotion | Poor | ≧80% | 3 | hours |

408. The data collection apparatus collects second vital sign data at the collection frequency.

After determining the collection frequency, the data collection apparatus collects the second vital sign data at the collection frequency, where the second vital sign data is vital sign data of the user.

The second vital sign data may be collected by the medical sensor, and another sensor may participant in the collection, which is not limited herein.

409. The data collection apparatus obtains a user health state by means of analysis according to the second vital sign data.

After collecting the second vital sign data, the data collection apparatus obtains the user health state by means of analysis according to the second vital sign data.

The data collection apparatus may use a current user health state as a real-time user health state; or may obtain a corresponding user health state according to a statistical average value of second deviation parameters within a preset time and use the corresponding user health state as a statistical health state, which is not limited herein.

410. The data collection apparatus notifies the user if the user health state reaches a preset state.

After the data collection apparatus obtains the user health state by means of analysis, the data collection apparatus notifies the user if the user health state reaches the preset state.

The preset state may be preset before the data collection apparatus leaves the factory, or may be set in a user-defined manner, which is not limited herein.

It may be understood that the data collection apparatus may notify the user in many manners, such as playing the user health state in an audio manner, displaying the user health state on a screen, and reminding the user by means of vibration, which is not limited herein.

411. The data collection apparatus provides the user with health advice according to the user health state.

After obtaining the user health state, the data collection apparatus provides the user with the health advice according to the user health state.

The health advice may be preset inside the data collection apparatus; or the health advice may be provided by an expert system according to the user health state, and then transmitted to the data collection apparatus, which is not limited herein.

In this embodiment of the present invention, after collecting second vital sign data of a user, a data collection apparatus obtains a user health state by means of analysis according to the second vital sign data and performs subsequent processing according to the user health state. In this way, the second vital sign data collected by the data collection apparatus is better utilized, so that the user can learn a health state in real time, thereby improving user experience.

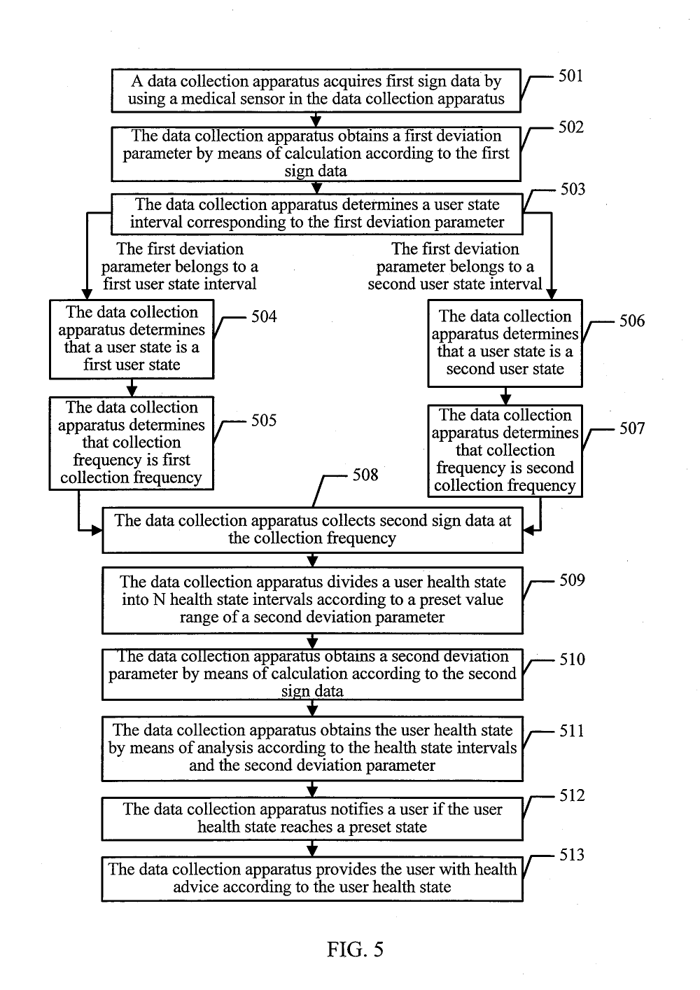

In the foregoing embodiment, after collecting second vital sign data, a data collection apparatus obtains a user health state by means of analysis according to the second vital sign data. In an actual application, after collecting the second vital sign data, the data collection apparatus may first obtain a second deviation parameter by means of calculation according to the second vital sign data, and search for a corresponding user health state interval according to the second deviation parameter to obtain the user health state by means of analysis. The following describes a data collection method in the embodiments of the present invention in detail. Referring to FIG. 5, another embodiment of the data collection method in the embodiments of the present invention includes:

501. A data collection apparatus acquires first vital sign data by using a medical sensor in the data collection apparatus.

After starting to work, the data collection apparatus acquires the first vital sign data by using the medical sensor in the data collection apparatus, where the first vital sign data is vital sign data of a user.

It may be understood that there are many manners for triggering the data collection apparatus to start to acquire the first vital sign data. Acquiring may be triggered by means of a physical switch, touch control, timing control, and the like; or it may be that the acquiring starts only after the user selects to activate a particular function, such as a sign monitoring function, which is not limited herein.

The first vital sign data may be single point data or may be multipoint data, which is not limited herein.

502. The data collection apparatus obtains a first deviation parameter by means of calculation according to the first vital sign data.

After acquiring the first vital sign data, the data collection apparatus obtains the first deviation parameter by means of calculation with reference to a normal sign range of healthy people.

The first deviation parameter may be a user sign deviation percentage, and a calculation formula may be

$$Sign deviation percentage \% = \vert ( \frac{2 \times {sign}_{first} - ( \begin{matrix}Health {sign}^{upperlimit value} + \\ Health {sign}^{lowerlimit value}\end{matrix} )}{Health {sign}^{upperlimit value} - Health {sign}^{lowerlimit value}} ) \times 100 \% \vert ;$$

or the first deviation parameter may be a difference between the first vital sign data and a health sign average value, which is not limited herein.

503. The data collection apparatus determines a user state interval corresponding to the first deviation parameter.

After obtaining the first deviation parameter by means of calculation, the data collection apparatus determines the user state interval corresponding to the first deviation parameter.

If it is determined that the first deviation parameter belongs to a first user state, perform step 504.

If it is determined that the first deviation parameter belongs to a second user state, perform step 506.

The data collection apparatus may divide a user state into two user state intervals according to the first deviation parameter, for example, it is specified that a range of a first deviation parameter in a first user state interval is from 0 and 50% and a corresponding user state is good, and it is specified that a range of a first deviation parameter in a second user state interval is greater than 50% and a corresponding user state is poor; or a user state may be divided into three user state intervals according to the first deviation parameter, for example, it is specified that a range of a first deviation parameter in a first user state interval is from 0 and 30% and a corresponding user state is excellent, it is specified that a first deviation parameter in a second user state interval is from 30% and 80% and a corresponding user state is medium, and it is specified that a range of a first deviation parameter in a third user state interval is greater than 80% and a corresponding user state is poor, which is not limited herein.

504. The data collection apparatus determines that a user state is a first user state.

If the data collection apparatus determines that the first deviation parameter belongs to the first user state, the data collection apparatus determines that the user state is the first user state.

505. The data collection apparatus determines that collection frequency is first collection frequency.

After determining that the user state is the first user state, the data collection apparatus determines that the collection frequency is the first collection frequency.

Collection frequency corresponding to each user state, that is, a corresponding time interval between two times of data collection, may be preset during initialization of the data collection apparatus, or may be set in a user-defined manner, which is not limited herein.

506. The data collection apparatus determines that a user state is a second user state.

If the data collection apparatus determines that the first deviation parameter belongs to the second user state, the data collection apparatus determines that the user state is the second user state.

507. The data collection apparatus determines that collection frequency is second collection frequency.

After determining that the user state is the second user state, the data collection apparatus determines that the collection frequency is the second collection frequency. If a value of a first deviation parameter in the first user state interval is less than or equal to a value of a first deviation parameter in the second user state interval, the first collection frequency is less than the second collection frequency.

It may be understood that the data collection apparatus may divide the user state into two user state intervals according to the first deviation parameter, and the two user states are corresponding to two types of collection frequency respectively; or may divide the user state into three user state intervals according to the first deviation parameter, and the three user states are corresponding to three types of collection frequency respectively, which is not limited herein.

In an actual application, the medical sensor in the data collection apparatus may include a temperature sensor that can acquire a shell temperature parameter of the user, may include a vibration sensor that can acquire a pulse parameter of the user, may include a pressure sensor that can acquire a blood pressure parameter of the user, may include a flow sensor that can acquire a respiration parameter of the user, may include a heat flux sensor that can acquire a blood glucose parameter of the user, or may include a bioelectrical sensor that can acquire an emotion parameter of the user, which is not limited herein. Parameters obtained by all types of sensors may be calculated together to obtain a first deviation parameter and obtain a comprehensive user state, where the comprehensive user state is corresponding to one type of collection frequency; or it may be that a first deviation parameter of each type of data is obtained by means of calculation to obtain a user state corresponding to each type of data, where the user state is corresponding to collection frequency of each type of sensor, which is not limited herein. As shown in Table 3 in the following, three types of sensors obtain three types of first deviation data, and each type of first deviation data is divided into data in three user state intervals.

TABLE 3

| | | First deviation | Collection | |
|---|---|---|---|---|
| Type | User state | parameter | frequency | |
| Blood pressure/ | Excellent | 0-30% | 12 | hours |
| Blood glucose | Medium | 30-80% | 2 | hours |
| | Poor | ≧80% | 1 | hour |
| Pulse/ | Excellent | 0-30% | 12 | hours |
| Respiration | Medium | 30-80% | 4 | hours |
| | Poor | ≧80% | 2 | hours |
| Shell | Excellent | 0-30% | 12 | hours |
| temperature/ | Medium | 30-80% | 6 | hours |
| Emotion | Poor | ≧80% | 3 | hours |

508. The data collection apparatus collects second vital sign data at the collection frequency.

After determining the collection frequency, the data collection apparatus collects the second vital sign data at the collection frequency, where the second vital sign data is vital sign data of the user.

The second vital sign data may be collected by the medical sensor, and another sensor may participant in the collection, which is not limited herein.

509. The data collection apparatus divides a user health state into N health state intervals according to a preset value range of a second deviation parameter.

The data collection apparatus divides the user health state into the N health state intervals according to the preset value range of the second deviation parameter, where N is a positive integer.

There are many manners for user state interval division; and based on the value range of the second deviation parameter, the user health state may be divided into three user health state intervals, where the three user health state intervals are corresponding to three user health states respectively; or based on the value range of the second deviation parameter, the user health state may be divided into four user health state intervals, where the four user health state intervals are corresponding to four user health states respectively, for example, it is a high health state when the value range of the second deviation parameter is from 0 and 30%, it is a medium health state when the value range of the second deviation parameter is from 30% and 80%, it is a low health state when the value range of the second deviation parameter is from 80% and 120%, and it is a dangerous state when the value range of the second deviation parameter is greater than 120%, which is not limited herein.

510. The data collection apparatus obtains a second deviation parameter by means of calculation according to the second vital sign data.

After collecting the second vital sign data, the data collection apparatus obtains the second deviation parameter by means of calculation with reference to the normal sign range of healthy people.

A method for calculating the second deviation parameter may be the same as a method for calculating the first deviation parameter, or another calculation method may be used, which is not limited herein.

511. The data collection apparatus obtains the user health state by means of analysis according to the health state intervals and the second deviation parameter.

The data collection apparatus searches, according to the health state intervals, for a health state interval corresponding to the second deviation parameter, and obtains a health state represented by the health state interval, that is, the user health state.

The data collection apparatus may use a current user health state as a real-time user health state, or may obtain a corresponding user health state according to a statistical average value of second deviation parameters within a preset time and use the corresponding user health state as a statistical health state, which is not limited herein.

512. The data collection apparatus notifies the user if the user health state reaches a preset state.

After the data collection apparatus obtains the user health state by means of analysis, the data collection apparatus notifies the user if the user health state reaches the preset state.

The preset state may be preset before the data collection apparatus leaves the factory, or may be set in a user-defined manner, which is not limited herein.

It may be understood that the data collection apparatus may notify the user in many manners, such as playing the user health state in an audio manner, displaying the user health state on a screen, and reminding the user by means of vibration, which is not limited herein.

513. The data collection apparatus provides the user with health advice according to the user health state.

After obtaining the user health state, the data collection apparatus provides the user with the health advice according to the user health state.

In this embodiment of the present invention, a data collection apparatus divides a user health state into N health state intervals according to a preset value range of a second deviation parameter; after collecting second vital sign data, obtains a second deviation parameter by means of calculation; and obtains a user health state by searching for a health state interval corresponding to the second deviation parameter. In this way, user health state analysis is more standard and accurate.

For ease of understanding, the following describes the data collection method in this embodiment of the present invention in detail by using a specific application scenario:

A user activates a blood pressure monitoring function of a data collection apparatus by means of touchscreen control, and the apparatus reminds the user to confirm user information;

a pressure sensor in the data collection apparatus starts to work and collects first vital sign data of the user, that is, first-time blood pressure data;

the data collection apparatus determines, according to gender and age in the user information, that a corresponding normal blood pressure range of healthy people is from 90 mmHg and 140 mmHg for systolic blood pressure and is from 60 mmHg and 90 mmHg for diastolic blood pressure;

the data collection apparatus calculates, according to the first-time blood pressure data and the normal blood pressure range of healthy people, a first deviation parameter, that is, a blood pressure deviation percentage, which is specifically a systolic blood pressure deviation percentage and a diastolic blood pressure deviation percentage, and their calculation formulas are as follows:

$$Systolic blood pressure deviation percentage \% = \vert ( \frac{2 \times systolic blood {pressure}_{first \text{-} time} - ( 90 + 140 )}{140 - 90} ) \times 100 \% \vert$$

$$Diastolic blood pressure deviation percentage \% = \vert ( \frac{2 \times diastolic blood {pressure}_{first \text{-} time} - ( 60 + 90 )}{90 - 60} ) \times 100 \% \vert$$

if the first deviation parameter is 55% and a value range of a first deviation parameter in a third user state interval is from 30% and 80%, the data collection apparatus determines that the first deviation parameter belongs to the third user state interval;

the data collection apparatus finds that a user state corresponding to the third user state interval is medium;

the data collection apparatus determines that a collection period for the user state “medium” is 20 minutes;

the pressure sensor in the data collection apparatus collects second vital sign data of the user, that is, blood pressure data, in a period of 20 minutes;

the data collection apparatus obtains, by means of calculation according to the collected blood pressure data, that a second deviation parameter, that is, a blood pressure deviation percentage, is 45%;

the data collection apparatus determines that a user health state interval corresponding to 45% is a medium health state;

the data collection apparatus plays the user health state for the user in an audio manner;

the user selects to view health states within two weeks, and the data collection apparatus calculates an average value of second deviation parameters within the two weeks, so as to obtain that a user health state corresponding to the average value is a poor health state; and the data collection apparatus provides the user with health advice according to the poor health state.

2. A data collection apparatus first collects external state data and obtains an external state by means of analysis, and then acquires vital sign data and performs a subsequent analysis and processing operation.

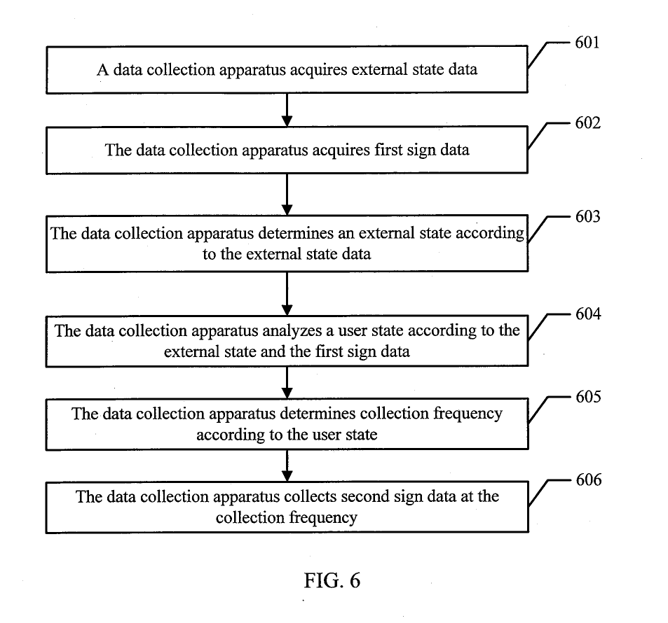

Referring to FIG. 6, another embodiment of a data collection method in the embodiments of the present invention includes:

601. A data collection apparatus acquires external state data.

The data collection apparatus acquires the external state data, where the external state data may indicate a state outside a user.

602. The data collection apparatus acquires first vital sign data.

The data collection apparatus acquires the first vital sign data, where the first vital sign data is vital sign data of the user.

603. The data collection apparatus determines an external state according to the external state data.

After acquiring the external state data, the data collection apparatus determines the external state according to the external state data.

The external state may be the user's own activity state or may be an environmental state around the user, which is not limited herein.

604. The data collection apparatus analyzes a user state according to the external state and the first vital sign data.

After determining the external state, the data collection apparatus analyzes the user state according to the acquired first vital sign data and with reference to the external state.

605. The data collection apparatus determines collection frequency according to the user state.

After obtaining the user state by means of analysis, the data collection apparatus determines the collection frequency according to the user state, where the collection frequency is used to indicate a time interval between two times of collection.

606. The data collection apparatus collects second vital sign data at the collection frequency.

After determining the collection frequency, the data collection apparatus collects the second vital sign data at the collection frequency, where the second vital sign data is vital sign data of the user.

In this embodiment of the present invention, a data collection apparatus first acquires external state data, and after determining an external state according to the external state data, analyzes a user state with reference to the external state and first vital sign data. In this way, user state analysis more fits in with an actual state of a user and makes it easier for the user to fully understand the user's own state.

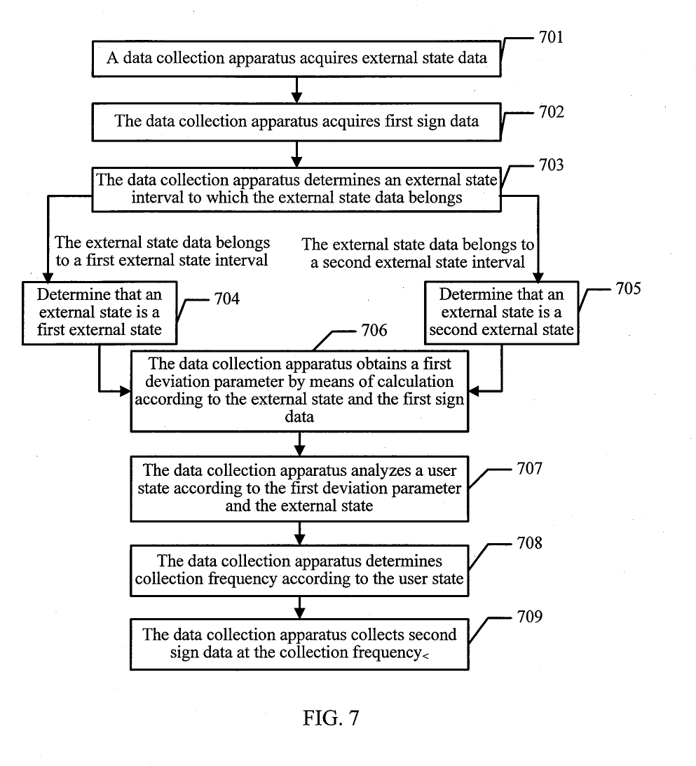

In the foregoing embodiment, a data collection apparatus determines an external state according to external state data. In an actual application, the data collection apparatus may first determine an external state interval to which the external state data belongs, and then obtain an external state corresponding to the external state interval. The following describes a data collection method in the embodiments of the present invention. Referring to FIG. 7, another embodiment of the data collection method in the embodiments of the present invention includes:

701. A data collection apparatus acquires external state data.

The data collection apparatus acquires the external state data, where the external state data may indicate a state outside a user.

It may be understood that there are many manners for triggering the data collection apparatus to start to acquire the external state data. Acquiring may be triggered by means of a physical switch, touch control, timing control, and the like; or it may be that the acquiring starts only after the user selects to activate a particular function, such as a sign monitoring function, which is not limited herein.

702. The data collection apparatus acquires first vital sign data.

The data collection apparatus acquires the first vital sign data, where the first vital sign data is vital sign data of the user.

The first vital sign data may be single point data or may be multipoint data, which is not limited herein.

703. The data collection apparatus determines an external state interval to which the external state data belongs.

Based on a value range of external state data, the data collection apparatus divides an external state into different external state intervals; and after acquiring the external state data, the data collection apparatus determines the external state interval to which the external state data belongs.

If it is determined that the external state data belongs to a first external state interval, perform step 704.

If it is determined that the external state data belongs to a second external state interval, perform step 705.

The external state may be the user's own activity state or may be an environmental state around the user, which is not limited herein.

The first external state interval may be an external state interval corresponding to a value range of external state data obtained when the user is in a normal environmental state and in a normal activity state; and the second external state interval may be an external state interval corresponding to a value range of external state data obtained when the user is in a harsh environmental state and in a strenuous activity state, which is not limited herein.

The data collection apparatus may divide the external state into two external state intervals, or may divide the external state into three external state intervals, which is not limited herein.

704. Determine that an external state is a first external state.

When it is determined that the external state data belongs to the first external state interval, the data collection apparatus determines that the external state is the first external state.

705. Determine that an external state is a second external state.

When it is determined that the external state data belongs to the second external state interval, the data collection apparatus determines that the external state is the second external state.

706. The data collection apparatus obtains a first deviation parameter by means of calculation according to the external state and the first vital sign data.

After determining the external state, the data collection apparatus obtains the first deviation parameter by means of calculation with reference to the first vital sign data and a normal sign range of healthy people that are in the external state.

707. The data collection apparatus analyzes a user state according to the first deviation parameter and the external state.

After obtaining the first deviation parameter, the data collection apparatus analyzes the user state according to the first deviation parameter and the external state.

708. The data collection apparatus determines collection frequency according to the user state.

After obtaining the user state by means of analysis, the data collection apparatus determines the collection frequency according to the user state, where the collection frequency is used to indicate a time interval between two times of collection.

In an actual application, different collection frequency may be preset according to different user states, or may be set by the user, which is not limited herein.

709. The data collection apparatus collects second vital sign data at the collection frequency.

After determining the collection frequency, the data collection apparatus collects the second vital sign data at the collection frequency, where the second vital sign data is vital sign data of the user.

The second vital sign data may be collected by a medical sensor, and another sensor may participant in the collection, which is not limited herein.

In this embodiment of the present invention, a data collection apparatus first determines an external state interval to which external state data belongs, and then obtains an external state corresponding to the external state interval. In this way, the external state can be determined more precisely.

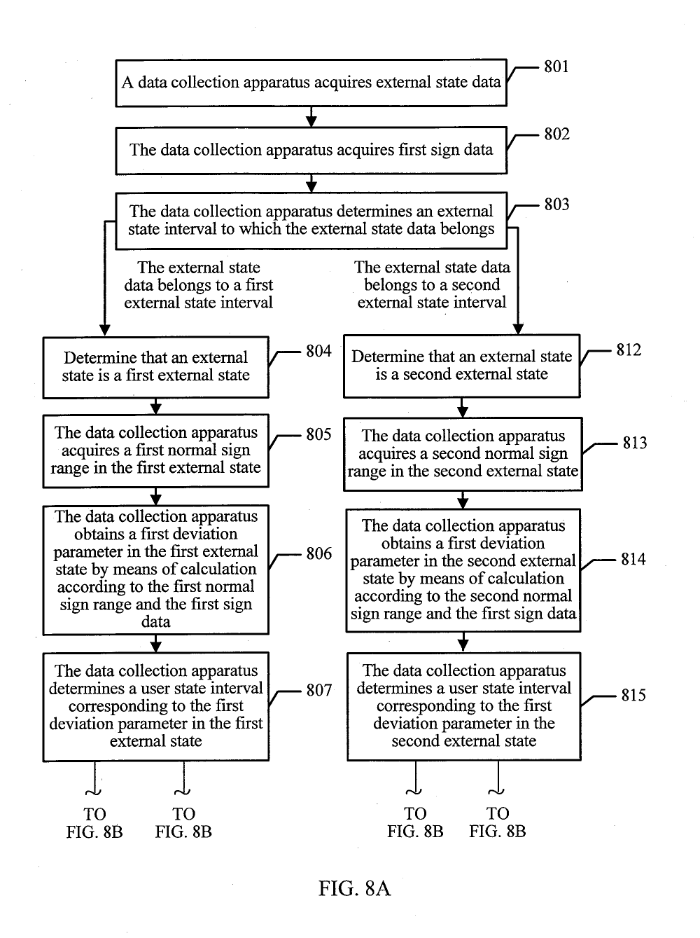

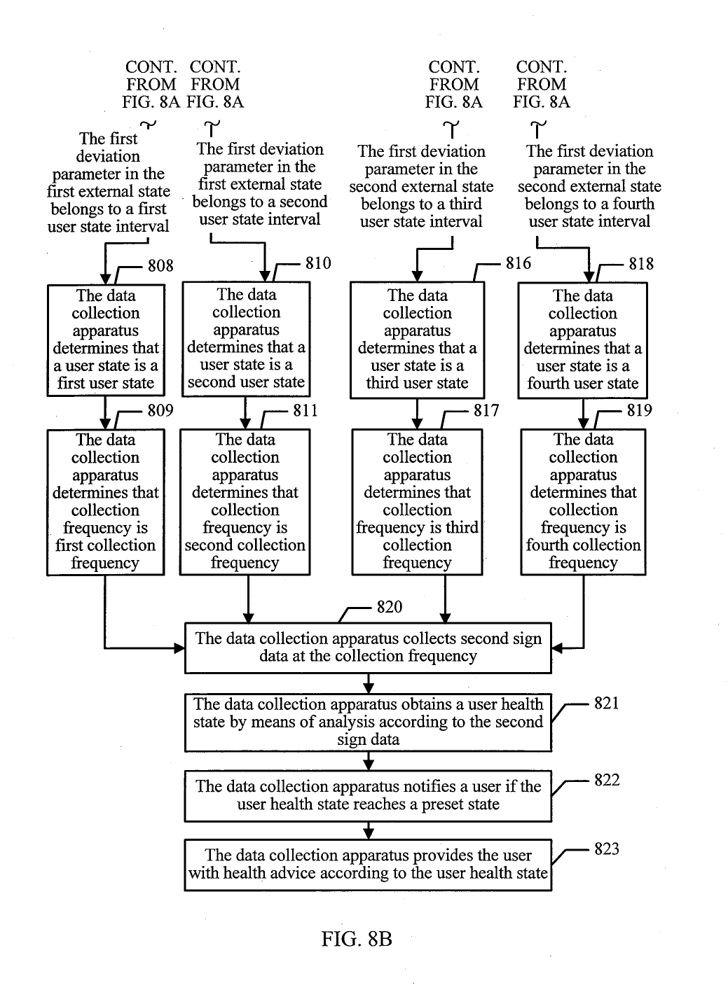

In the foregoing embodiment, a data collection apparatus obtains a first deviation parameter by means of calculation according to an external state and first vital sign data, and analyzes a user state. In an actual application, the data collection apparatus may obtain a first deviation parameter in a corresponding external state by means of calculation, determine a user state interval corresponding to the first deviation parameter, and then obtain a user state corresponding to the user state interval. The following describes a data collection method in the embodiments of the present invention in detail. Referring to FIG. 8A and FIG. 8B, another embodiment of the data collection method in the embodiments of the present invention includes:

801. A data collection apparatus acquires external state data.

The data collection apparatus acquires the external state data, where the external state data may indicate a state outside a user.

The data collection apparatus may acquire the external state data by using an ambient perception sensor, or may acquire the external state data by using an activity perception sensor, which is not limited herein.

It may be understood that there are many manners for triggering the data collection apparatus to start to acquire the external state data. Acquiring may be triggered by means of a physical switch, touch control, timing control, and the like; or it may be that the acquiring starts only after the user selects to activate a particular function, such as a sign monitoring function, which is not limited herein.

802. The data collection apparatus acquires first vital sign data.

The data collection apparatus acquires the first vital sign data, where the first vital sign data is vital sign data of the user.

The first vital sign data may be single point data or may be multipoint data, which is not limited herein.

803. The data collection apparatus determines an external state interval to which the external state data belongs.

Based on a value range of external state data, the data collection apparatus divides an external state into different external state intervals; and after acquiring the external state data, the data collection apparatus determines the external state interval to which the external state data belongs.

If it is determined that the external state data belongs to a first external state interval, perform step 804.

If it is determined that the external state data belongs to a second external state interval, perform step 812.

The external state may be the user's own activity state or may be an environmental state around the user, which is not limited herein.

The first external state interval may be an external state interval corresponding to a value range of external state data obtained when the user is in a normal environmental state and in a normal activity state; and the second external state interval may be an external state interval corresponding to a value range of external state data obtained when the user is in a harsh environmental state and in a strenuous activity state, which is not limited herein.

The data collection apparatus may divide the external state into two external state intervals, or may divide the external state into three external state intervals, which is not limited herein.

804. Determine that an external state is a first external state.

When it is determined that the external state data belongs to the first external state interval, the data collection apparatus determines that the external state is the first external state.

805. The data collection apparatus acquires a first normal sign range in the first external state.

After determining that the external state is the first external state, the data collection apparatus acquires the first normal sign range in the first external state, where the first normal sign range is a normal sign range of healthy people in the first external state.

806. The data collection apparatus obtains a first deviation parameter in the first external state by means of calculation according to the first normal sign range and the first vital sign data.

After obtaining the first normal sign range, the data collection apparatus obtains the first deviation parameter in the first external state by means of calculation with reference to the first vital sign data.

The first deviation parameter in the first external state may be a sign deviation percentage, or may be a difference between the first vital sign data and a normal sign range average value, which is not limited herein.

807. The data collection apparatus determines a user state interval corresponding to the first deviation parameter in the first external state.

After obtaining the first deviation parameter in the first external state by means of calculation, the data collection apparatus determines the user state interval corresponding to the first deviation parameter in the first external state.

If it is determined that the first deviation parameter in the first external state belongs to a first user state, perform step 808.

If it is determined that the first deviation parameter in the first external state belongs to a second user state, perform step 810.

The data collection apparatus may divide a user state into two user state intervals according to the first deviation parameter in the first external state, for example, it is specified that a range of a first deviation parameter in a first user state interval in the first external state is from 0 and 50% and a corresponding user state is good, and it is specified that a range of a first deviation parameter in a second user state interval in the first external state is greater than 50% and a corresponding user state is poor; or a user state may be divided into three user state intervals according to the first deviation parameter in the first external state, for example, it is specified that a range of a first deviation parameter in a first user state interval in the first external state is from 0 and 30% and a corresponding user state is excellent, it is specified that a range of a first deviation parameter in a second user state interval in the first external state is from 30% and 80% and a corresponding user state is medium, and it is specified that a range of a first deviation parameter in a third user state interval in the first external state is greater than 80% and a corresponding user state is poor, which is not limited herein.

808. The data collection apparatus determines that a user state is a first user state.

If the data collection apparatus determines that the first deviation parameter in the first external state belongs to the first user state, the data collection apparatus determines that the user state is the first user state.

809. The data collection apparatus determines that collection frequency is first collection frequency.

After determining that the user state is the first user state, the data collection apparatus determines that the collection frequency is the first collection frequency.

Collection frequency corresponding to each user state, that is, a corresponding time interval between two times of data collection, may be preset during initialization of the data collection apparatus, or may be set in a user-defined manner, which is not limited herein.

810. The data collection apparatus determines that a user state is a second user state.

If it is determined that the first deviation parameter in the first external state belongs to the second user state, the data collection apparatus determines that the user state is the second user state.

811. The data collection apparatus determines that collection frequency is second collection frequency.

After determining that the user state is the second user state, the data collection apparatus determines that the collection frequency is the second collection frequency.

812. Determine that an external state is a second external state.

When it is determined that the external state data belongs to the second external state interval, the data collection apparatus determines that the external state is the second external state.

813. The data collection apparatus acquires a second normal sign range in the second external state.

After determining that the external state is the second external state, the data collection apparatus acquires the second normal sign range in the second external state, where the second normal sign range is a normal sign range of healthy people in the second external state.

814. The data collection apparatus obtains a first deviation parameter in the second external state by means of calculation according to the second normal sign range and the first vital sign data.

After obtaining the second normal sign range, the data collection apparatus obtains the first deviation parameter in the second external state by means of calculation with reference to first vital sign data.

The first deviation parameter in the second external state may be a sign deviation percentage, or may be a difference between the first vital sign data and a normal sign range average value, which is not limited herein.

815. The data collection apparatus determines a user state interval corresponding to the first deviation parameter in the second external state.

After obtaining the first deviation parameter in the second external state by means of calculation, the data collection apparatus determines the user state interval corresponding to the first deviation parameter in the second external state.

If it is determined that the first deviation parameter in the second external state belongs to a third user state, perform step 816.

If it is determined that the first deviation parameter in the second external state belongs to a fourth user state, perform step 818.

The data collection apparatus may divide a user state into two user state intervals according to the first deviation parameter in the second external state, for example, it is specified that a range of a first deviation parameter in a third user state interval in the second external state is from 0 and 50% and a corresponding user state is good, and it is specified that a range of a first deviation parameter in a fourth user state interval in the second external state is greater than 50% and a corresponding user state is poor; or a user state may be divided into three user state intervals according to the first deviation parameter in the second external state, for example, it is specified that a range of a first deviation parameter in a fourth user state interval in the second external state is from 0 and 30% and a corresponding user state is excellent, it is specified that a range of a first deviation parameter in a fifth user state interval in the second external state is from 30% and 80% and a corresponding user state is medium, and it is specified that a range of a first deviation parameter in a sixth user state interval in the second external state is greater than 80% and a corresponding user state is poor, which is not limited herein.

816. The data collection apparatus determines that a user state is a third user state.

If the data collection apparatus determines that the first deviation parameter in the second external state belongs to the third user state, the data collection apparatus determines that the user state is the third user state.

817. The data collection apparatus determines that collection frequency is third collection frequency.

After determining that the user state is the third user state, the data collection apparatus determines that the collection frequency is the third collection frequency.

818. The data collection apparatus determines that a user state is a fourth user state.

If the data collection apparatus determines that the first deviation parameter in the second external state belongs to the fourth user state, the data collection apparatus determines that the user state is the fourth user state.

819. The data collection apparatus determines that collection frequency is fourth collection frequency.

After determining that the user state is the fourth user state, the data collection apparatus determines that the collection frequency is the fourth collection frequency.

In an actual application, a medical sensor in the data collection apparatus may include a temperature sensor that can acquire a shell temperature parameter of the user, may include a vibration sensor that can acquire a pulse parameter of the user, may include a pressure sensor that can acquire a blood pressure parameter of the user, may include a flow sensor that can acquire a respiration parameter of the user, may include a heat flux sensor that can acquire a blood glucose parameter of the user, or may include a bioelectrical sensor that can acquire an emotion parameter of the user, which is not limited herein.

The ambient perception sensor in the data collection apparatus may include a temperature and humidity sensor that can acquire a temperature and humidity parameter, may include a barometric pressure sensor that can acquire an altitude, or may include a sound sensor that can acquire noise intensity, which is not limited herein.

The activity perception sensor in the data collection apparatus may include an acceleration sensor that can acquire an acceleration parameter, may include a gyroscope that can acquire an orientation parameter, may include a camera that can acquire an action parameter, or may include a timer that can acquire a time parameter, which is not limited herein.

It may be understood that an external state may be obtained by synthesizing external state data obtained by all types of sensors; or it may be that an external state of each type of external state data is obtained, and then the external state corresponding to each type of data is divided into external state intervals for subsequent processing, which is not limited herein.

Parameters obtained by all types of sensors may be calculated together to obtain a first deviation parameter and obtain a comprehensive user state, where the comprehensive user state is corresponding to one type of collection frequency; or it may be that a first deviation parameter of each type of data is obtained by means of calculation to obtain a user state corresponding to each type of data, where the user state is corresponding to collection frequency of each type of sensor, which is not limited herein. As shown in Table 4 in the following, the external state is divided into two external state intervals; the medical sensor in the data collection apparatus is classified into three types to collect the first vital sign data and obtain three types of first deviation data; and each type of first deviation data is divided into data in three user state intervals.

TABLE 4

| | | | Collection | | Collection | |
|---|---|---|---|---|---|---|
| | | First | frequency in a | | frequency in a | |
| | | deviation | first external | | second external | |
| Type | User state | parameter | state | | state | |
| Blood pressure/ | Excellent | 0-30% | 12 | hours | 30 | minutes |
| Blood glucose | Medium | 30-80% | 2 | hours | 20 | minutes |
| | Poor | ≧80% | 1 | hour | 15 | minutes |
| Pulse/ | Excellent | 0-30% | 12 | hours | 10 | minutes |
| Respiration | Medium | 30-80% | 4 | hours | 5 | minutes |
| | Poor | ≧80% | 2 | hours | 2 | minutes |
| Shell | Excellent | 0-30% | 12 | hours | 10 | minutes |
| temperature/ | Medium | 30-80% | 6 | hours | 5 | minutes |
| Emotion | Poor | ≧80% | 3 | hours | 2 | minutes |

820. The data collection apparatus collects second vital sign data at the collection frequency.

After determining the collection frequency, the data collection apparatus collects the second vital sign data at the collection frequency, where the second vital sign data is vital sign data of the user.

The second vital sign data may be collected by the medical sensor; and another sensor may participant in the collection, which is not limited herein.

821. The data collection apparatus obtains a user health state by means of analysis according to the second vital sign data.

After collecting the second vital sign data, the data collection apparatus obtains the user health state by means of analysis according to the second vital sign data.

The data collection apparatus may use a current user health state as a real-time user health state; or may obtain a corresponding user health state according to a statistical average value of second deviation parameters within a preset time and use the corresponding user health state as a statistical health state, which is not limited herein.

822. The data collection apparatus notifies the user if the user health state reaches a preset state.

After the data collection apparatus obtains the user health state by means of analysis, the data collection apparatus notifies the user if the user health state reaches the preset state.

The preset state may be preset before the data collection apparatus leaves the factory, or may be set in a user-defined manner, which is not limited herein.

It may be understood that the data collection apparatus may notify the user in many manners, such as playing the user health state in an audio manner, displaying the user health state on a screen, and reminding the user by means of vibration, which is not limited herein.

823. The data collection apparatus provides the user with health advice according to the user health state.

After obtaining the user health state, the data collection apparatus provides the user with the health advice according to the user health state.

The health advice may be preset inside the data collection apparatus; or the health advice may be provided by an expert system according to the user health state, and then transmitted to the data collection apparatus, which is not limited herein.

In this embodiment of the present invention, after determining an external state, a data collection apparatus obtains a first deviation parameter in a corresponding external state by means of calculation, determines a user state interval corresponding to the first parameter, and then obtains a user state corresponding to the user state interval. In this way, a process of user state analysis is more standard, and the user state can be analyzed more accurately.

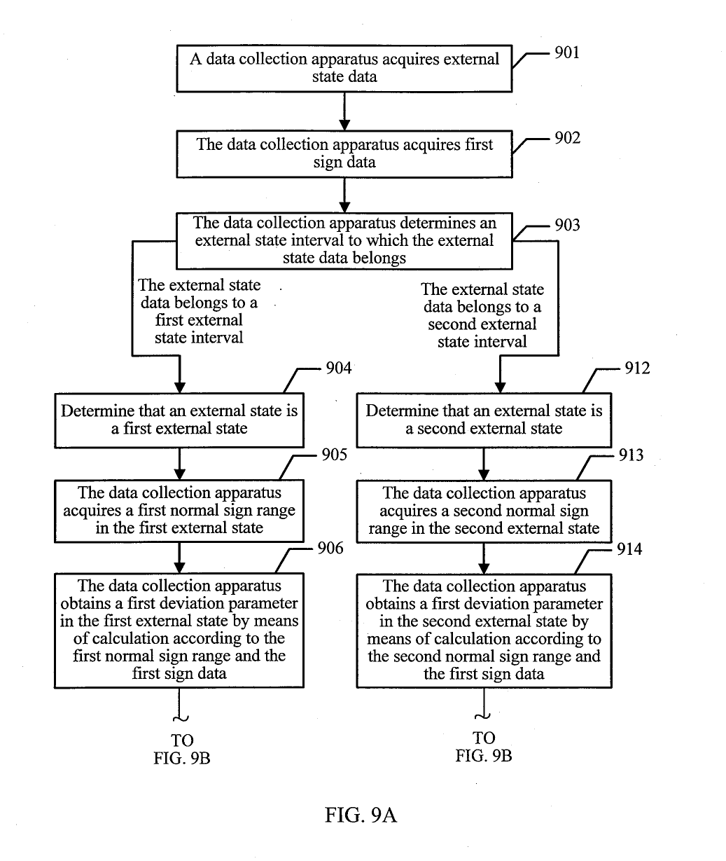

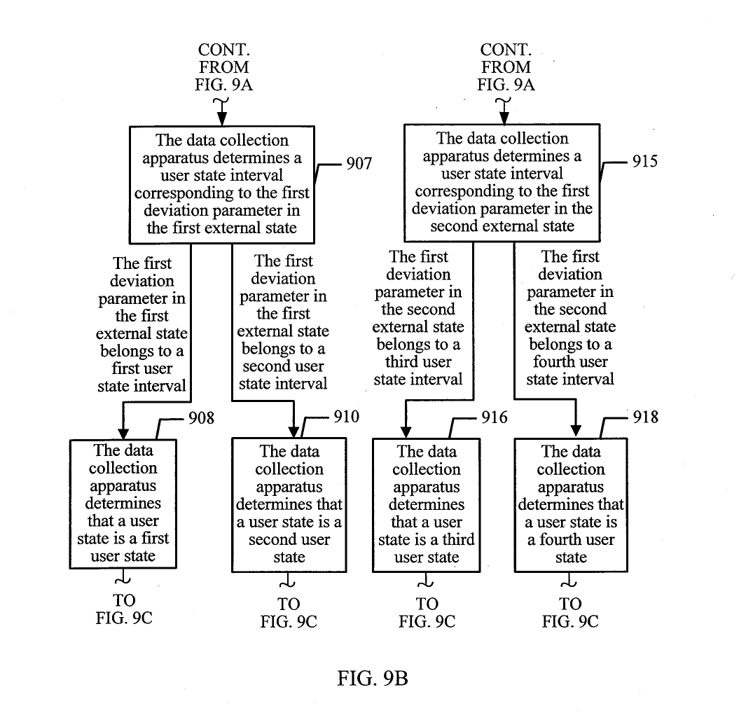

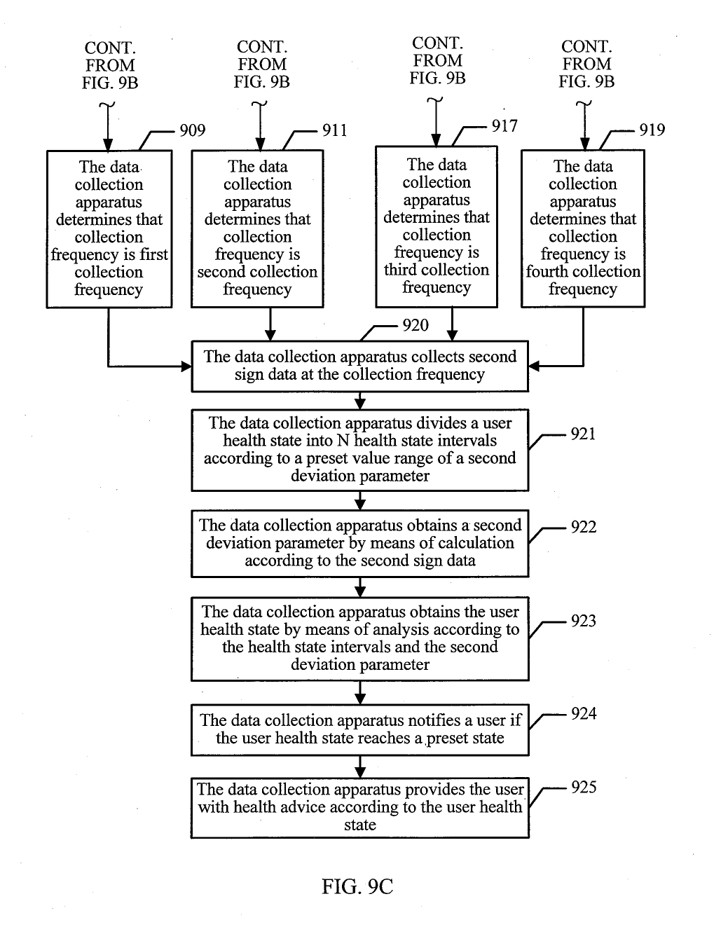

In the foregoing embodiment, after collecting second vital sign data, a data collection apparatus obtains a user health state by means of analysis according to the second vital sign data. In an actual application, after collecting the second vital sign data, the data collection apparatus may first obtain a second deviation parameter by means of calculation according to the second vital sign data, and search for a corresponding user health interval according to the second deviation parameter to obtain the user health state by means of analysis. The following describes a data collection method in the embodiments of the present invention in detail. Referring to FIG. 9A, FIG. 9B and FIG. 9C, another embodiment of the data collection method in the embodiments of the present invention includes:

901. A data collection apparatus acquires external state data.

The data collection apparatus acquires the external state data, where the external state data may indicate a state outside a user.

The data collection apparatus may acquire the external state data by using an ambient perception sensor, or may acquire the external state data by using an activity perception sensor, which is not limited herein.

It may be understood that there are many manners for triggering the data collection apparatus to start to acquire the external state data. Acquiring may be triggered by means of a physical switch, touch control, timing control, and the like; or it may be that the acquiring starts only after the user selects to activate a particular function, such as a sign monitoring function, which is not limited herein.

902. The data collection apparatus acquires first vital sign data.

The data collection apparatus acquires the first vital sign data, where the first vital sign data is vital sign data of the user.

The first vital sign data may be single point data or may be multipoint data, which is not limited herein.

903. The data collection apparatus determines an external state interval to which the external state data belongs.

Based on a value range of external state data, the data collection apparatus divides an external state into different external state intervals; and after acquiring the external state data, the data collection apparatus determines the external state interval to which the external state data belongs.

If it is determined that the external state data belongs to a first external state interval, perform step 904.

If it is determined that the external state data belongs to a second external state interval, perform step 912.

The external state may be the user's own activity state or may be an environmental state around the user, which is not limited herein.

The first external state interval may be an external state interval corresponding to a value range of external state data obtained when the user is in a normal environmental state and in a normal activity state; and the second external state interval may be an external state interval corresponding to a value range of external state data obtained when the user is in a harsh environmental state and in a strenuous activity state, which is not limited herein.

The data collection apparatus may divide the external state into two external state intervals, or may divide the external state into three external state intervals, which is not limited herein.

904. Determine that an external state is a first external state.

When it is determined that the external state data belongs to the first external state interval, the data collection apparatus determines that the external state is the first external state.

905. The data collection apparatus acquires a first normal sign range in the first external state.

After determining that the external state is the first external state, the data collection apparatus acquires the first normal sign range in the first external state, where the first normal sign range is a normal sign range of healthy people in the first external state.

906. The data collection apparatus obtains a first deviation parameter in the first external state by means of calculation according to the first normal sign range and the first vital sign data.

After obtaining the first normal sign range, the data collection apparatus obtains the first deviation parameter in the first external state by means of calculation with reference to the first vital sign data.

The first deviation parameter in the first external state may be a sign deviation percentage, or may be a difference between the first vital sign data and a normal sign range average value, which is not limited herein.

907. The data collection apparatus determines a user state interval corresponding to the first deviation parameter in the first external state.

After obtaining the first deviation parameter in the first external state by means of calculation, the data collection apparatus determines the user state interval corresponding to the first deviation parameter in the first external state.

If it is determined that the first deviation parameter in the first external state belongs to a first user state, perform step 908.

If it is determined that the first deviation parameter in the first external state belongs to a second user state, perform step 910.

The data collection apparatus may divide a user state into two user state intervals according to the first deviation parameter in the first external state, for example, it is specified that a range of a first deviation parameter in a first user state interval in the first external state is from 0 and 50% and a corresponding user state is good, and it is specified that a range of a first deviation parameter in a second user state interval in the first external state is greater than 50% and a corresponding user state is poor; or a user state may be divided into three user state intervals according to the first deviation parameter in the first external state, for example, it is specified that a range of a first deviation parameter in a first user state interval in the first external state is from 0 and 30% and a corresponding user state is excellent, it is specified that a range of a first deviation parameter in a second user state interval in the first external state is from 30% and 80% and a corresponding user state is medium, and it is specified that a range of a first deviation parameter in a third user state interval in the first external state is greater than 80% and a corresponding user state is poor, which is not limited herein.

908. The data collection apparatus determines that a user state is a first user state.

If the data collection apparatus determines that the first deviation parameter in the first external state belongs to the first user state, the data collection apparatus determines that the user state is the first user state.

909. The data collection apparatus determines that collection frequency is first collection frequency.

After determining that the user state is the first user state, the data collection apparatus determines that the collection frequency is the first collection frequency.

Collection frequency corresponding to each user state, that is, a corresponding time interval between two times of data collection, may be preset during initialization of the data collection apparatus, or may be set in a user-defined manner, which is not limited herein.

910. The data collection apparatus determines that a user state is a second user state.

If it is determined that the first deviation parameter in the first external state belongs to the second user state, the data collection apparatus determines that the user state is the second user state.

911. The data collection apparatus determines that collection frequency is second collection frequency.

After determining that the user state is the second user state, the data collection apparatus determines that the collection frequency is the second collection frequency.

912. Determine that an external state is a second external state.

When it is determined that the external state data belongs to the second external state interval, the data collection apparatus determines that the external state is the second external state.

913. The data collection apparatus acquires a second normal sign range in the second external state.

After determining that the external state is the second external state, the data collection apparatus acquires the second normal sign range in the second external state, where the second normal sign range is a normal sign range of healthy people in the second external state.

914. The data collection apparatus obtains a first deviation parameter in the second external state by means of calculation according to the second normal sign range and the first vital sign data.

After obtaining the second normal sign range, the data collection apparatus obtains the first deviation parameter in the second external state by means of calculation with reference to first vital sign data.

The first deviation parameter in the second external state may be a sign deviation percentage, or may be a difference between the first vital sign data and a normal sign range average value, which is not limited herein.

915. The data collection apparatus determines a user state interval corresponding to the first deviation parameter in the second external state.

After obtaining the first deviation parameter in the second external state by means of calculation, the data collection apparatus determines the user state interval corresponding to the first deviation parameter in the second external state.

If it is determined that the first deviation parameter in the second external state belongs to a third user state, perform step 916.

If it is determined that the first deviation parameter in the second external state belongs to a fourth user state, perform step 918.

The data collection apparatus may divide a user state into two user state intervals according to the first deviation parameter in the second external state, for example, it is specified that a range of a first deviation parameter in a third user state interval in the second external state is from 0 and 50% and a corresponding user state is good, and it is specified that a range of a first deviation parameter in a fourth user state interval in the second external state is greater than 50% and a corresponding user state is poor; or a user state may be divided into three user state intervals according to the first deviation parameter in the second external state, for example, it is specified that a range of a first deviation parameter in a fourth user state interval in the second external state is from 0 and 30% and a corresponding user state is excellent, it is specified that a range of a first deviation parameter in a fifth user state interval in the second external state is from 30% and 80% and a corresponding user state is medium, and it is specified that a range of a first deviation parameter in a sixth user state interval in the second external state is greater than 80% and a corresponding user state is poor, which is not limited herein.

916. The data collection apparatus determines that a user state is a third user state.

If the data collection apparatus determines that the first deviation parameter in the second external state belongs to the third user state, the data collection apparatus determines that the user state is the third user state.

917. The data collection apparatus determines that collection frequency is third collection frequency.

After determining that the user state is the third user state, the data collection apparatus determines that the collection frequency is the third collection frequency.

918. The data collection apparatus determines that a user state is a fourth user state.

If the data collection apparatus determines that the first deviation parameter in the second external state belongs to the fourth user state, the data collection apparatus determines that the user state is the fourth user state.

919. The data collection apparatus determines that collection frequency is fourth collection frequency.

After determining that the user state is the fourth user state, the data collection apparatus determines that the collection frequency is the fourth collection frequency.

In an actual application, a medical sensor in the data collection apparatus may include a temperature sensor that can acquire a shell temperature parameter of the user, may include a vibration sensor that can acquire a pulse parameter of the user, may include a pressure sensor that can acquire a blood pressure parameter of the user, may include a flow sensor that can acquire a respiration parameter of the user, may include a heat flux sensor that can acquire a blood glucose parameter of the user, or may include a bioelectrical sensor that can acquire an emotion parameter of the user, which is not limited herein.

The ambient perception sensor in the data collection apparatus may include a temperature and humidity sensor that can acquire a temperature and humidity parameter, may include a barometric pressure sensor that can acquire an altitude, or may include a sound sensor that can acquire noise intensity, which is not limited herein.

The activity perception sensor in the data collection apparatus may include an acceleration sensor that can acquire an acceleration parameter, may include a gyroscope that can acquire an orientation parameter, may include a camera that can acquire an action parameter, or may include a timer that can acquire a time parameter, which is not limited herein.

It may be understood that an external state may be obtained by synthesizing external state data obtained by all types of sensors; or it may be that an external state of each type of external state data is obtained, and then the external state corresponding to each type of data is divided into external state intervals for subsequent processing, which is not limited herein.

Parameters obtained by all types of sensors may be calculated together to obtain a first deviation parameter and obtain a comprehensive user state, where the comprehensive user state is corresponding to one type of collection frequency; or it may be that a first deviation parameter of each type of data is obtained by means of calculation to obtain a user state corresponding to each type of data, where the user state is corresponding to collection frequency of each type of sensor, which is not limited herein. As shown in Table 5 in the following, the external state is divided into two external state intervals; the medical sensor in the data collection apparatus is classified into three types to collect the first vital sign data and obtain three types of first deviation data; and each type of first deviation data is divided into data in three user state intervals.

TABLE 5

| | | | Collection | | Collection | |
|---|---|---|---|---|---|---|
| | | First | frequency in a | | frequency in a | |
| | | deviation | first external | | second external | |
| Type | User state | parameter | state | | state | |
| Blood pressure/ | Excellent | 0-30% | 12 | hours | 30 | minutes |
| Blood glucose | Medium | 30-80% | 2 | hours | 20 | minutes |
| | Poor | ≧80% | 1 | hour | 15 | minutes |
| Pulse/ | Excellent | 0-30% | 12 | hours | 10 | minutes |
| Respiration | Medium | 30-80% | 4 | hours | 5 | minutes |
| | Poor | ≧80% | 2 | hours | 2 | minutes |
| Shell | Excellent | 0-30% | 12 | hours | 10 | minutes |
| temperature/ | Medium | 30-80% | 6 | hours | 5 | minutes |
| Emotion | Poor | ≧80% | 3 | hours | 2 | minutes |

920. The data collection apparatus collects second vital sign data at the collection frequency.

After determining the collection frequency, the data collection apparatus collects the second vital sign data at the collection frequency, where the second vital sign data is vital sign data of the user.

The second vital sign data may be collected by the medical sensor, and another sensor may participant in the collection, which is not limited herein.

921. The data collection apparatus divides a user health state into N health state intervals according to a preset value range of a second deviation parameter.

The data collection apparatus divides the user health state into the N health state intervals according to the preset value range of the second deviation parameter, where N is a positive integer.

There are many manners for user state interval division; and based on the value range of the second deviation parameter, the user health state may be divided into three user health state intervals, where the three user health state intervals are corresponding to three user health states respectively; or based on the value range of the second deviation parameter, the user health state may be divided into four user health state intervals, where the four user health state intervals are corresponding to four user health states respectively, for example, it is a excellent health state when the value range of the second deviation parameter is from 0 and 30%, it is a medium health state when the value range of the second deviation parameter is from 30% and 80%, it is a poor health state when the value range of the second deviation parameter is from 80% and 120%, and it is a dangerous state when the value range of the second deviation parameter is greater than 120%, which is not limited herein.

922. The data collection apparatus obtains a second deviation parameter by means of calculation according to the second vital sign data.

After collecting the second vital sign data, the data collection apparatus obtains the second deviation parameter by means of calculation with reference to the normal sign range of healthy people.

A method for calculating the second deviation parameter may be the same as a method for calculating the first deviation parameter, or another calculation method may be used, which is not limited herein.

923. The data collection apparatus obtains the user health state by means of analysis according to the health state intervals and the second deviation parameter.

The data collection apparatus may use a current user health state as a real-time user health state, or may obtain a corresponding user health state according to a statistical average value of second deviation parameters within a preset time and use the corresponding user health state as a statistical health state, which is not limited herein.

924. The data collection apparatus notifies the user if the user health state reaches a preset state.

After the data collection apparatus obtains the user health state by means of analysis, the data collection apparatus notifies the user if the user health state reaches the preset state.

The preset state may be preset before the data collection apparatus leaves the factory, or may be set in a user-defined manner, which is not limited herein.

It may be understood that the data collection apparatus may notify the user in many manners, such as playing the user health state in an audio manner, displaying the user health state on a screen, and reminding the user by means of vibration, which is not limited herein.

925. The data collection apparatus provides the user with health advice according to the user health state.

After obtaining the user health state, the data collection apparatus provides the user with the health advice according to the user health state.

The health advice may be preset inside the data collection apparatus, or the health advice may be provided by an expert system according to the user health state, and then transmitted to the data collection apparatus, which is not limited herein.

In this embodiment of the present invention, a data collection apparatus divides a user health state into N health state intervals according to a preset value range of a second deviation parameter; after collecting second vital sign data, obtains a second deviation parameter by means of calculation; and obtains a user health state by searching for a health state interval corresponding to the second deviation parameter. In this way, user health state analysis is more standard and accurate.

For ease of understanding, the following describes the data collection method in this embodiment of the present invention in detail by using a specific application scenario:

A user activates a pulse monitoring and situation awareness function of a data collection apparatus by using a physical switch, and the data collection apparatus reminds the user to confirm user information;

a pulse vibration sensor in the data collection apparatus acquires first-time pulse data of the user; a temperature and humidity sensor in the data collection apparatus acquires temperature and humidity in an environment; a barometric pressure sensor acquires an altitude; a sound sensor acquires noise intensity; an acceleration sensor acquires an acceleration parameter; a gyroscope acquires a orientation parameter; and a timer records activity time;

according to environmental state data and activity state data that are obtained by means of measurement, the data collection apparatus determines that the user runs for more than 30 minutes and swims for more than 20 minutes, so that the data collection apparatus determines that the user is in a strenuous activity state;

the data collection apparatus acquires a normal sign range of healthy people in the strenuous activity state;

the data collection apparatus obtains, by means of calculation according to the first-time pulse data and the normal sign range of healthy people that are in the strenuous activity state, that a pulse deviation percentage in the strenuous activity state is 20%, and a calculation formula is as follows:

$$Pulse de viation percentage \% = \vert ( \frac{2 \times {pulse}_{first \text{-} time} - ( 108 + 134 )}{134 - 108} ) \times 100 \% \vert$$

the data collection apparatus determines a user state interval corresponding to the pulse deviation percentage 20%;

the data collection apparatus determines that a user state corresponding to the user state interval is good;

the data collection apparatus determines that a collection period for the user state “good” in the strenuous activity state is 10 minutes;

the pulse vibration sensor in the data collection apparatus collects pulse data of the user in a period of 10 minutes;

the data collection apparatus obtains, by calculation, according to the collected pulse data, that the pulse deviation percentage is 18%;

the data collection apparatus determines that a user health state interval corresponding to 18% is a excellent health state;

the data collection apparatus plays the user health state for the user in an audio manner;

the user selects to view health states within two weeks, and the data collection apparatus calculates an average value of second deviation parameters within the two weeks, so as to obtain that a user health state corresponding to the average value is a medium health state; and the data collection apparatus provides the user with health advice according to the medium health state.

The following describes a data collection apparatus in the embodiments of the present invention. The data collection apparatus in the embodiments of the present invention may directly acquire first vital sign data and perform subsequent processing according to the first vital sign data; or may first acquire external state data and determine an external state, and then perform subsequent processing with reference to the external state.

1. A data collection apparatus directly acquires first vital sign data and performs subsequent processing according to the first vital sign data.

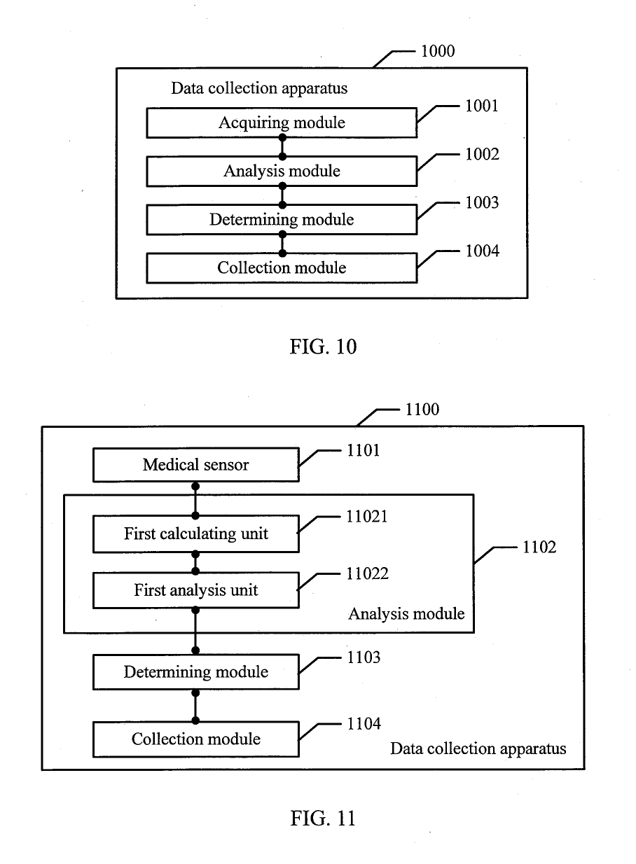

Referring to FIG. 10, an embodiment of a data collection apparatus 1000 in the embodiments of the present invention includes:

an acquiring module 1001, configured to acquire first vital sign data;

an analysis module 1002, configured to analyze a user state according to the first vital sign data acquired by the acquiring module 1001;

a determining module 1003, configured to determine collection frequency according to the user state obtained by means of analysis by the analysis module 1002; and

a collection module 1004, configured to collect second vital sign data at the collection frequency determined by the determining module 1003.

In this embodiment of the present invention, an acquiring module 1001 detects vital sign data; an analysis module 1002 obtains a user state by means of analysis; a determining module 1003 determines collection frequency according to the user state; and a collection module 1004 performs user data collection at the collection frequency. In this way, the collection frequency becomes an adjustable dynamic parameter and varies with the user state; the collection frequency is adjusted intelligently, which more fits in with actual use of a user; and if the user is in a good state, the collection frequency is decreased, and if the user is in a poor state, the collection frequency is increased, thereby achieving a balance between power consumption and an effect.

In the foregoing embodiment, the analysis module 1002 may first obtain a first deviation parameter by means of calculation, and then analyze a user state according to the first deviation parameter. Referring to FIG. 11, another embodiment of a data collection apparatus 1100 in the embodiments of the present invention includes:

an acquiring module 1101, configured to acquire first vital sign data;

an analysis module 1102, configured to analyze a user state according to the first vital sign data acquired by the acquiring module 1101;

a determining module 1103, configured to determine collection frequency according to the user state obtained by means of analysis by the analysis module 1102; and

a collection module 1104, configured to collect second vital sign data at the collection frequency determined by the determining module 1103.

In this embodiment, the acquiring module 1101 is specifically a medical sensor 1101; and

the analysis module 1102 specifically includes:

a first calculating unit 11021, configured to obtain a first deviation parameter by means of calculation according to the first vital sign data acquired by the medical sensor 1101; and

a first analysis unit 11022, configured to analyze the user state according to the first deviation parameter obtained by means of calculation by the first calculating unit 11021.

In this embodiment of the present invention, a medical sensor 1101 first acquires first vital sign data, and after a first calculating unit 11021 obtains a first deviation parameter by means of calculation according to the first vital sign data, a first analysis unit 11022 analyzes a user state according to the first deviation parameter. In this way, user state analysis is more detailed, and the obtained user state is more accurate.

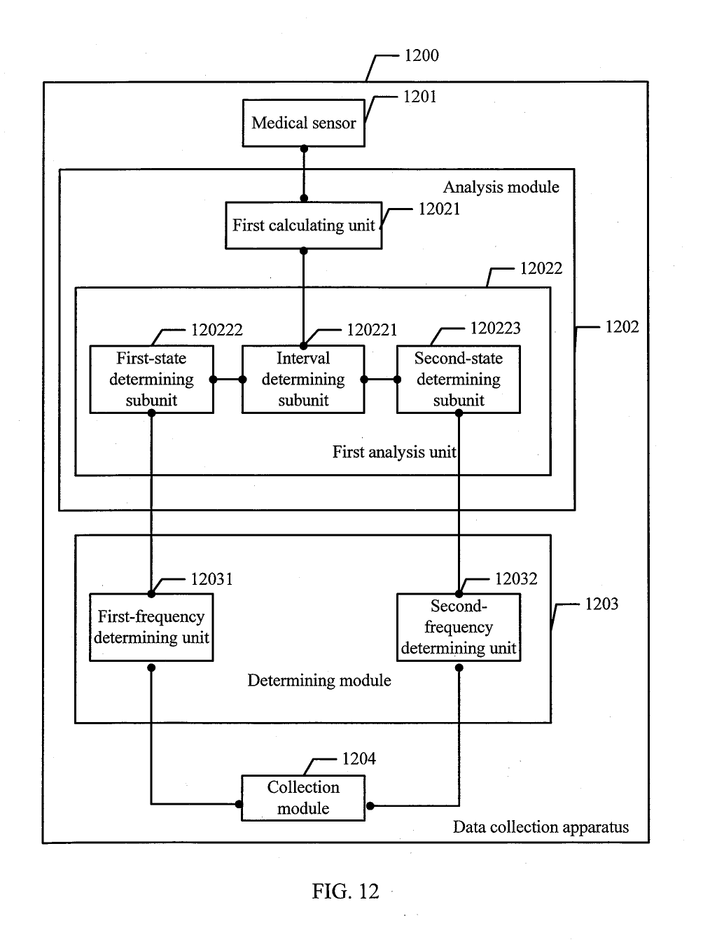

In the foregoing embodiment, the first analysis unit 11022 may first determine a user state interval corresponding to a first deviation parameter, and then determine a user state according to the user state interval. The following describes a data collection apparatus in the embodiments of the present invention. Referring to FIG. 12, another embodiment of a data collection apparatus 1200 in the embodiments of the present invention includes:

an acquiring module 1201, configured to acquire first vital sign data;

an analysis module 1202, configured to analyze a user state according to the first vital sign data acquired by the acquiring module 1201;

a determining module 1203, configured to determine collection frequency according to the user state obtained by means of analysis by the analysis module 1202; and

a collection module 1204, configured to collect second vital sign data at the collection frequency determined by the determining module 1203.

The acquiring module 1201 is specifically a medical sensor 1201; and the analysis module 1202 specifically includes:

a first calculating unit 12021, configured to obtain a first deviation parameter by means of calculation according to the first vital sign data acquired by the medical sensor 1201; and

a first analysis unit 12022, configured to analyze the user state according to the first deviation parameter obtained by means of calculation by the first calculating unit 12021.

In this embodiment, the first analysis unit 12022 specifically includes:

an interval determining subunit 120221, configured to determine a user state interval corresponding to the first deviation parameter obtained by means of calculation by the first calculating unit 12021;

a first-state determining subunit 120222, configured to: when the first deviation parameter obtained by means of calculation by the first calculating unit 12021 belongs to a first user state interval, determine that the user state is a first user state; and

a second-state determining subunit 120223, configured to: when the first deviation parameter obtained by means of calculation by the first calculating unit 12021 belongs to a second user state interval, determine that the user state is a second user state, where a value of a first deviation parameter in the first user state interval is less than or equal to a value of a first deviation parameter in the second user state interval.

The determining module 1203 specifically includes:

a first-frequency determining module 12031, configured to: when the first-state determining subunit 120222 determines that the user state is the first user state, determine that the collection frequency is first collection frequency; and

a second-frequency determining module 12032, configured to: when the second-state determining subunit 120223 determines that the user state is the second user state, determine that the collection frequency is second collection frequency, where the first collection frequency is less than the second collection frequency.

In this embodiment of the present invention, after a medical sensor 1201 obtains a first deviation parameter, an interval determining subunit 120221 first determines a user state interval corresponding to the first deviation parameter, and then a first-state determining subunit 120222 and a second-state determining subunit 120223 determine a user state according to the user state interval. In this way, determining of a user state is more accurate, and different user states are corresponding to different collection frequency, so that data collection of a data collection apparatus better meets a requirement of a user.

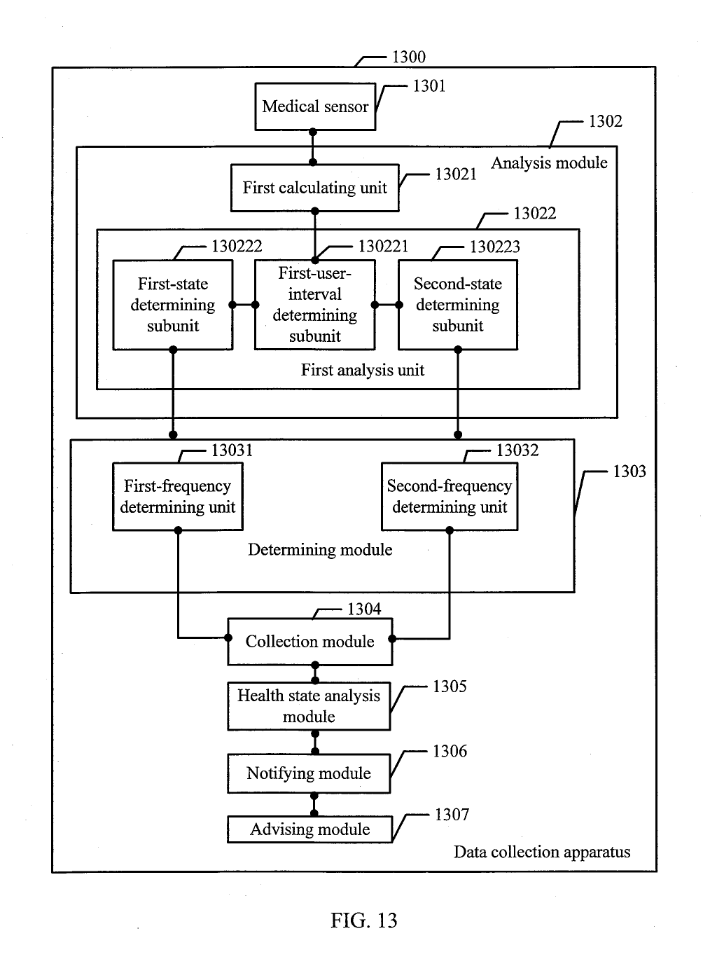

In the foregoing embodiment, the data collection apparatus may further analyze a health state according to collected second vital sign data, notify a user, and provide the user with health advice. Referring to FIG. 13, another embodiment of a data collection apparatus 1300 in the embodiments of the present invention includes:

an acquiring module 1301, configured to acquire first vital sign data;

an analysis module 1302, configured to analyze a user state according to the first vital sign data acquired by the acquiring module 1301;

a determining module 1303, configured to determine collection frequency according to the user state obtained by means of analysis by the analysis module 1302; and

a collection module 1304, configured to collect second vital sign data at the collection frequency determined by the determining module 1303.

The acquiring module 1301 is specifically a medical sensor 1301; and

the analysis module 1302 specifically includes:

a first calculating unit 13021, configured to obtain a first deviation parameter by means of calculation according to the first vital sign data acquired by the medical sensor 1301; and

a first analysis unit 13022, configured to analyze the user state according to the first deviation parameter obtained by means of calculation by the first calculating unit 13021.

The first analysis unit 13022 specifically includes:

an interval determining subunit 130221, configured to determine a user state interval corresponding to the first deviation parameter obtained by means of calculation by the first calculating unit 13021;

a first-state determining subunit 130222, configured to: when the first deviation parameter obtained by means of calculation by the first calculating unit 13021 belongs to a first user state interval, determine that the user state is a first user state; and

a second-state determining subunit 130223, configured to: when the first deviation parameter obtained by means of calculation by the first calculating unit 13021 belongs to a second user state interval, determine that the user state is a second user state, where a value of a first deviation parameter in the first user state interval is less than or equal to a value of a first deviation parameter in the second user state interval.

The determining module 1303 specifically includes:

a first-frequency determining module 13031, configured to: when the first-state determining subunit 130222 determines that the user state is the first user state, determine that the collection frequency is first collection frequency; and

a second-frequency determining module 13032, configured to: when the second-state determining subunit 130223 determines that the user state is the second user state, determine that the collection frequency is second collection frequency, where the first collection frequency is less than the second collection frequency.

In this embodiment, the data collection apparatus further includes:

a health state analysis module 1305, configured to obtain a user health state by means of analysis according to the second vital sign data collected by the collection module 1304;

a notifying module 1306, configured to notify a user when the user health state obtained by means of analysis by the health state analysis module 1305 reaches a preset state; and

an advising module 1307, configured to provide the user with health advice according to the user health state obtained by means of analysis by the health state analysis module 1305.

In this embodiment of the present invention, after a collection module 1304 collects second vital sign data of a user, a health state analysis module 1305 obtains a user health state by means of analysis according to the second vital sign data, and a notifying module 1306 and an advising module 1307 perform subsequent processing according to the user health state. In this way, the second vital sign data collected by the data collection apparatus is better utilized, so that the user can learn a health state in real time, thereby improving user experience.

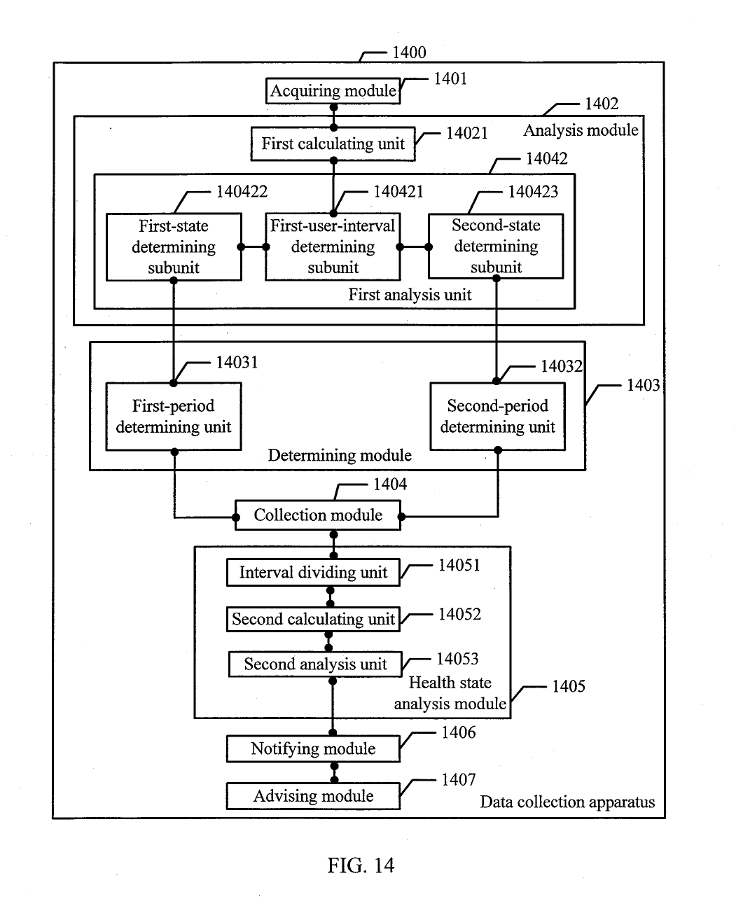

In the foregoing embodiment, the health state analysis module 1305 may first obtain a second deviation parameter by means of calculation according to second vital sign data, and then find a user health interval corresponding to the second deviation parameter, so as to obtain a user health state by means of analysis. The following describes a data collection apparatus in the embodiments of the present invention in detail. Referring to FIG. 14, another embodiment of a data collection apparatus 1400 in the embodiments of the present invention includes:

an acquiring module 1401, configured to acquire first vital sign data;

an analysis module 1402, configured to analyze a user state according to the first vital sign data acquired by the acquiring module 1401;

a determining module 1403, configured to determine collection frequency according to the user state obtained by means of analysis by the analysis module 1402; and

a collection module 1404, configured to collect second vital sign data at the collection frequency determined by the determining module 1403.

The acquiring module 1401 is specifically a medical sensor 1401; and

the analysis module 1402 specifically includes:

a first calculating unit 14021, configured to obtain a first deviation parameter by means of calculation according to the first vital sign data acquired by the medical sensor 1401; and

a first analysis unit 14022, configured to analyze the user state according to the first deviation parameter obtained by means of calculation by the first calculating unit 14021.

The first analysis unit 14022 specifically includes:

an interval determining subunit 140221, configured to determine a user state interval corresponding to the first deviation parameter obtained by means of calculation by the first calculating unit 14021;

a first-state determining subunit 140222, configured to: when the first deviation parameter obtained by means of calculation by the first calculating unit 14021 belongs to a first user state interval, determine that the user state is a first user state; and

a second-state determining subunit 140223, configured to: when the first deviation parameter obtained by means of calculation by the first calculating unit 14021 belongs to a second user state interval, determine that the user state is a second user state, where a value of a first deviation parameter in the first user state interval is less than or equal to a value of a first deviation parameter in the second user state interval.

The determining module 1403 specifically includes:

a first-frequency determining module 14031, configured to: when the first-state determining subunit 140222 determines that the user state is the first user state, determine that the collection frequency is first collection frequency; and

a second-frequency determining module 14032, configured to: when the second-state determining subunit 140223 determines that the user state is the second user state, determine that the collection frequency is second collection frequency, where the first collection frequency is less than the second collection frequency.

The data collection apparatus further includes:

a health state analysis module 1405, configured to obtain a user health state by means of analysis according to the second vital sign data collected by the collection module 1404;

a notifying module 1406, configured to notify a user when the user health state obtained by means of analysis by the health state analysis module 1405 reaches a preset state; and

an advising module 1407, configured to provide the user with health advice according to the user health state obtained by means of analysis by the health state analysis module 1405.

In this embodiment, the health state analysis module 1405 specifically includes:

an interval dividing unit 14051, configured to divide a user health state into N health state intervals according to a preset value range of a second deviation parameter, where N is a positive integer;

a second calculating unit 14052, configured to obtain a second deviation parameter by means of calculation according to the second vital sign data collected by the collection module 1404; and

a second analysis unit 14053, configured to obtain the user health state by means of analysis according to the health state intervals obtained by means of division by the interval dividing unit 14051 and the second deviation parameter obtained by means of calculation by the second calculating unit 14052.

In this embodiment of the present invention, an interval dividing unit 14051 divides a user health state into N health state intervals according to a preset value range of a second deviation parameter; after a collection module 1404 collects second vital sign data, a second calculating unit 14052 obtains a second deviation parameter by means of calculation, and a second analysis unit 14053 obtains a user health state by searching for a health state interval corresponding to the second deviation parameter. In this way, user health state analysis is more standard and accurate.

For ease of understanding the foregoing embodiment, the following describes an interaction process of all units of the foregoing data collection apparatus 1400 by using a specific application scenario:

A user activates a blood pressure monitoring function of the data collection apparatus by means of touchscreen control, and the apparatus reminds the user to confirm user information;

a pressure sensor in the data collection apparatus starts to work and collects first vital sign data of the user, that is, first-time blood pressure data;

the data collection apparatus determines, according to gender and age in the user information, that a corresponding normal blood pressure range of healthy people is from 90 mmHg and 140 mmHg for systolic blood pressure and is from 60 mmHg and 90 mmHg for diastolic blood pressure;

the first calculating unit 14021 calculates, according to the first-time blood pressure data and the normal blood pressure range of healthy people, a first deviation parameter, that is, a blood pressure deviation percentage, which is specifically a systolic blood pressure deviation percentage and a diastolic blood pressure deviation percentage, and their calculation formulas are as follows:

$$Systolic blood pressure deviation percentage \% = \vert ( \frac{2 \times systolic blood {pressure}_{first \text{-} time} - ( 90 + 140 )}{140 - 90} ) \times 100 \% \vert$$

$$Diastolic blood pressure deviation percentage \% = \vert ( \frac{2 \times diastolic blood {pressure}_{first \text{-} time} - ( 60 + 90 )}{90 - 60} ) \times 100 \% \vert$$

if the first deviation parameter is 55% and a value range of a first deviation parameter in a third user state interval is from 30% and 80%, a first-interval determining subunit 140421 determines that the first deviation parameter belongs to the third user state interval;

the first-state determining subunit 140222 finds that a user state corresponding to the third user state interval is medium;

the first-frequency determining subunit 14031 determines that a collection period for the user state “medium” is 20 minutes;

the collection module 1404 collects second vital sign data of the user, that is, blood pressure, in a period of 20 minutes;

the second calculating unit 14052 obtains, by means of calculation according to the collected blood pressure, that a second deviation parameter, that is, a blood pressure deviation percentage, is 45%;

the second analysis unit 14053 determines that a user health state interval corresponding to 45% is a medium health state;

the notifying module 1406 plays the user health state for the user in an audio manner;

the user selects to view health states within two weeks, and the second analysis unit 14053 calculates an average value of second deviation parameters within the two weeks, so as to obtain that a user health state corresponding to the average value is a poor health state; and

the advising module 1407 provides the user with health advice according to the poor health state.

2. A data collection apparatus first acquires external state data, and after determining an external state according to the external state data, performs a subsequent data collection processing process with reference to the external state.

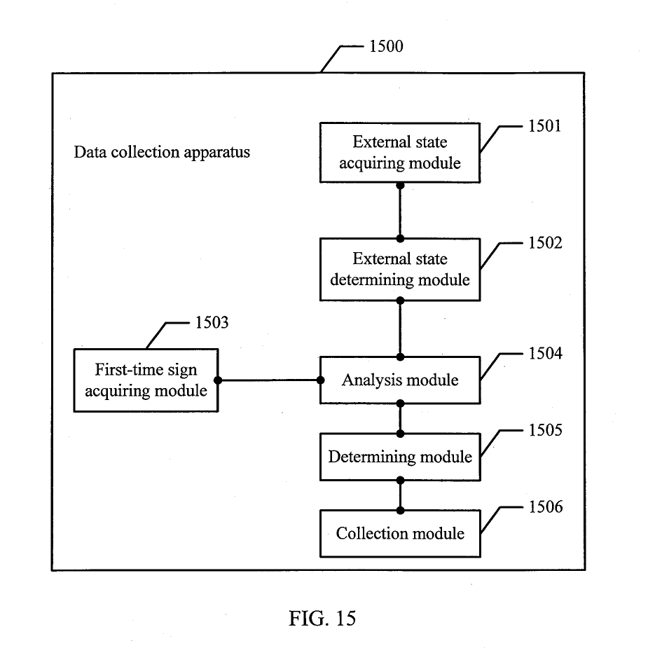

Referring to FIG. 15, another embodiment of a data collection apparatus 1500 in the embodiments of the present invention includes:

an external state acquiring module 1501, configured to acquire external state data;

an external state determining module 1502, configured to determine an external state according to the external state data acquired by the external state acquiring module 1501;

a first-time sign acquiring module 1503, configured to acquire first vital sign data;

an analysis module 1504, configured to analyze a user state according to the external state determined by the external state determining module 1502 and the first vital sign data acquired by the first-time sign acquiring module 1503;

a determining module 1505, configured to determine collection frequency according to the user state obtained by means of analysis by the analysis module 1504; and

a collection module 1506, configured to collect second vital sign data at the collection frequency determined by the determining module 1505.

In this embodiment of the present invention, an external state acquiring module 1501 first acquires external state data, and after an external state determining module 1502 determines an external state according to the external state data, an analysis module 1504 analyzes a user state with reference to the external state and first vital sign data. In this way, user state analysis more fits in with an actual state of a user and makes it easier for the user to fully understand the user's own state.

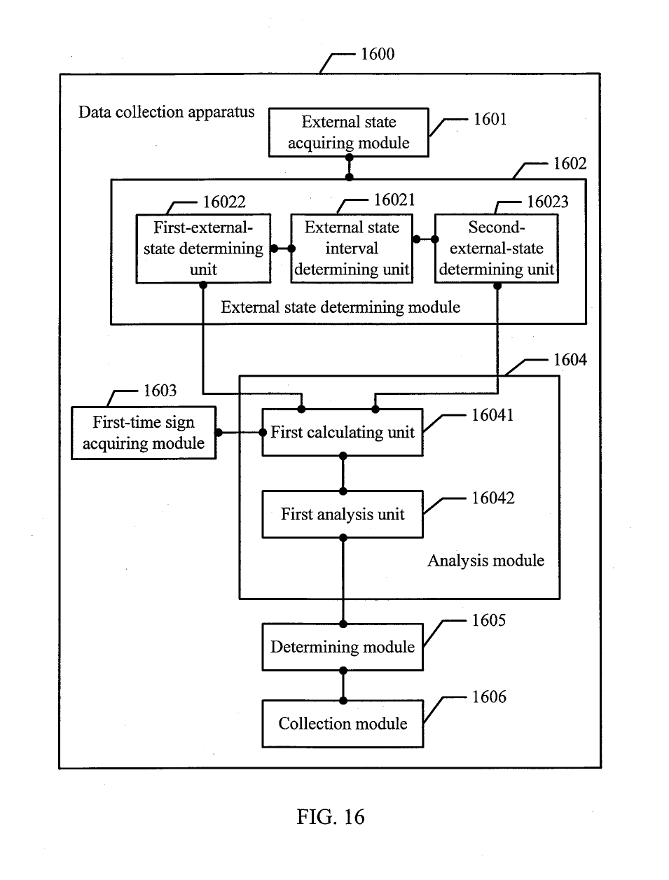

In the foregoing embodiment, the external state determining module 1502 may first determine an external state interval to which external state data belongs, and then determine an external state corresponding to the external state interval. Referring to FIG. 16, another embodiment of a data collection apparatus 1600 in the embodiments of the present invention includes:

an external state acquiring module 1601, configured to acquire external state data;

an external state determining module 1602, configured to determine an external state according to the external state data acquired by the external state acquiring module 1601;

a first-time sign acquiring module 1603, configured to acquire first vital sign data;

an analysis module 1604, configured to analyze a user state according to the external state determined by the external state determining module 1602 and the first vital sign data acquired by the first-time sign acquiring module 1603;

a determining module 1605, configured to determine collection frequency according to the user state obtained by means of analysis by the analysis module 1604; and

a collection module 1606, configured to collect second vital sign data at the collection frequency determined by the determining module 1605.

In this embodiment, the external state determining module 1602 specifically includes:

an external state interval determining unit 16021, configured to determine an external state interval to which the external state data acquired by the external state acquiring module 1601 belongs;

a first-external-state determining unit 16022, configured to: when the external state interval determining unit 16021 determines that the external state data belongs to a first external state interval, determine that the external state is a first external state; and a second-external-state determining unit 16023, configured to: when the external state interval determining unit 16021 determines that the external state data belongs to a second external state interval, determine that the external state is a second external state.

The analysis module 1604 specifically includes:

a first calculating unit 16041, configured to obtain a first deviation parameter by means of calculation according to the external state determined by the external state determining module 1602 and the first vital sign data acquired by the first-time sign acquiring module 1603; and

a first analysis unit 16042, configured to analyze the user state according to the first deviation parameter obtained by means of calculation by the first calculating unit 16041 and the external state determined by the external state determining module 1602.

In this embodiment of the present invention, an external state interval determining unit 16021 first determines an external state interval to which external state data belongs, and then a first-external-state determining unit 16022 and a second-external-state determining unit 16023 obtain an external state corresponding to the external state interval. In this way, a process of determining an external state is faster.

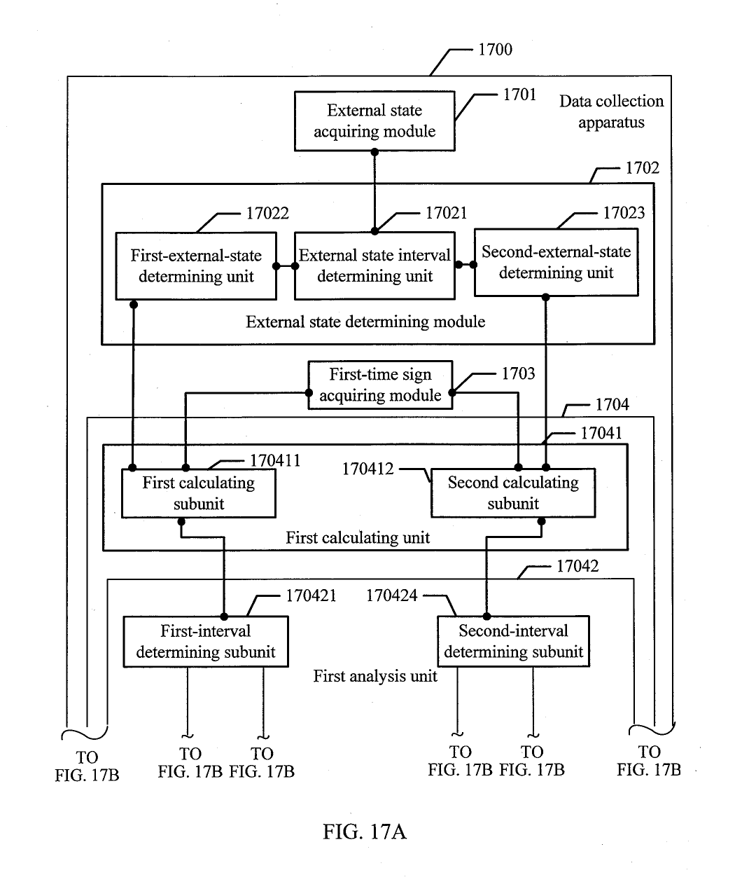

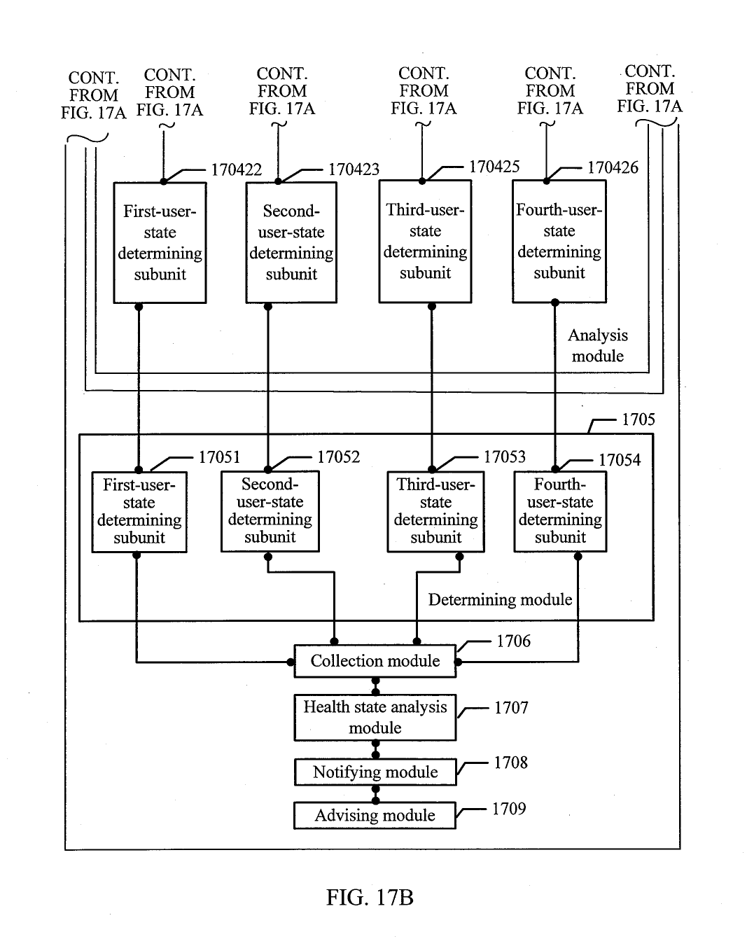

In the foregoing embodiment, the first calculating unit 16041 may obtain a first deviation parameter in a corresponding external state by means of calculation according to an external state determined by the external state determining module 1602, and the first analysis unit 1604 may obtain a user state by analyzing first deviation parameters in different external states. The following describes a data collection apparatus in the embodiments of the present invention in detail. Referring to FIG. 17A and FIG. 17B, another embodiment of a data collection apparatus 1700 in the embodiments of the present invention includes:

an external state acquiring module 1701, configured to acquire external state data;

an external state determining module 1702, configured to determine an external state according to the external state data acquired by the external state acquiring module 1701;

a first-time sign acquiring module 1703, configured to acquire first vital sign data;

an analysis module 1704, configured to analyze a user state according to the external state determined by the external state determining module 1702 and the first vital sign data acquired by the first-time sign acquiring module 1703;

a determining module 1705, configured to determine collection frequency according to the user state obtained by means of analysis by the analysis module 1704; and

a collection module 1706, configured to collect second vital sign data at the collection frequency determined by the determining module 1705.

The external state determining module 1702 specifically includes:

an external state interval determining unit 17021, configured to determine an external state interval to which the external state data acquired by the external state acquiring module 1701 belongs;

a first-external-state determining unit 17022, configured to: when the external state interval determining unit 17021 determines that the external state data belongs to a first external state interval, determine that the external state is a first external state; and

a second-external-state determining unit 17023, configured to: when the external state interval determining unit 17021 determines that the external state data belongs to a second external state interval, determine that the external state is a second external state.

The analysis module 1704 specifically includes:

a first calculating unit 17041, configured to obtain a first deviation parameter by means of calculation according to the external state determined by the external state determining module 1702 and the first vital sign data acquired by the first-time sign acquiring module 1703; and

a first analysis unit 17042, configured to analyze the user state according to the first deviation parameter obtained by means of calculation by the first calculating unit 17041 and the external state determined by the external state determining module 1702.

In this embodiment, the first calculating unit 17041 specifically includes:

a first calculating subunit 170411, configured to: when the external state determined by the external state determining module 1702 is the first external state, acquire a first normal sign range in the first external state, and obtain a first deviation parameter in the first external state by means of calculation according to the first normal sign range and the first vital sign data that is acquired by the first-time sign acquiring module 1703; and

a second calculating subunit 170412, configured to: when the external state determined by the external state determining module 1702 is the second external state, acquire a second normal sign range in the second external state, and obtain a first deviation parameter in the second external state by means of calculation according to the second normal sign range and the first vital sign data that is acquired by the first-time sign acquiring module 1703.

The first analysis module 17042 specifically includes:

a first-interval determining subunit 170421, configured to: when the external state determined by the external state determining module 1702 is the first external state, determine a user state interval corresponding to the first deviation parameter that is in the first external state and obtained by means of calculation by the first calculating subunit 170411;

a first-user-state determining subunit 170422, configured to: when the first deviation parameter that is in the first external state and obtained by means of calculation by the first calculating subunit 170411 belongs to a first user state interval, determine that the user state is a first user state;

a second-user-state determining subunit 170423, configured to: when the first deviation parameter that is in the first external state and obtained by means of calculation by the first calculating subunit 170411 belongs to a second user state interval, determine that the user state is a second user state, where a value of a first deviation parameter in the first user state interval is less than or equal to a value of a first deviation parameter in the second user state interval;

a second-interval determining subunit 170424, configured to: when the external state determined by the external state determining module 1702 is the second external state, determine a user state interval corresponding to the first deviation parameter that is in the second external state and obtained by means of calculation by the second calculating subunit 170412;

a third-user-state determining subunit 170425, configured to: when the first deviation parameter that is in the second external state and obtained by means of calculation by the second calculating subunit 170412 belongs to a third user state interval, determine that the user state is a third user state; and

a fourth-user-state determining subunit 170426, configured to: when the first deviation parameter that is in the second external state and obtained by means of calculation by the second calculating subunit 170412 belongs to a fourth user state interval, determine that the user state is a fourth user state, where a value of a first deviation parameter in the third user state interval is less than or equal to a value of a first deviation parameter in the fourth user state interval.

The determining module 1705 specifically includes:

a first-frequency determining unit 17051, configured to: when the user state determined by the first-user-state determining subunit 170422 is the first user state, determine that the collection frequency is first collection frequency;

a second-frequency determining unit 17052, configured to: when the user state determined by the second-user-state determining subunit 170423 is the second user state, determine that the collection frequency is second collection frequency, where the first collection frequency is less than the second collection frequency;

a third-frequency determining unit 17053, configured to: when the user state determined by the third-user-state determining subunit 170425 is the third user state, determine that the collection frequency is third collection frequency; and

a fourth-frequency determining unit 17054, configured to: when the user state determined by the fourth-user-state determining subunit 170426 is the fourth user state, determine that the collection frequency is fourth collection frequency, where the third collection frequency is less than the fourth collection frequency.

The data collection apparatus further includes:

a health state analysis module 1707, configured to obtain a user health state by means of analysis according to the second vital sign data collected by the collection module 1706;

a notifying module 1708, configured to notify a user when the user health state obtained by means of analysis by the health state analysis module 1707 reaches a preset state; and

an advising module 1709, configured to provide the user with health advice according to the user health state obtained by means of analysis by the health state analysis module 1707.

In this embodiment of the present invention, after an external state determining module 1702 determines an external state, a first calculating subunit 170411 and a second calculating subunit 170412 each obtain a first deviation parameter in a corresponding external state by means of calculation; a first-user-state determining subunit 170422, a second-user-state determining subunit 170423, a third-user-state determining subunit 170425, and a fourth-user-state determining subunit 170426 each determine a user state interval corresponding to the first parameter; then, a first-frequency determining unit 17051, a second-frequency determining unit 17052, a third-frequency determining unit 17053, and a fourth-frequency determining unit 17054 each obtain a user state corresponding to the user state interval. In this way, a process of user state analysis is more standard, and the user state can be analyzed more accurately.

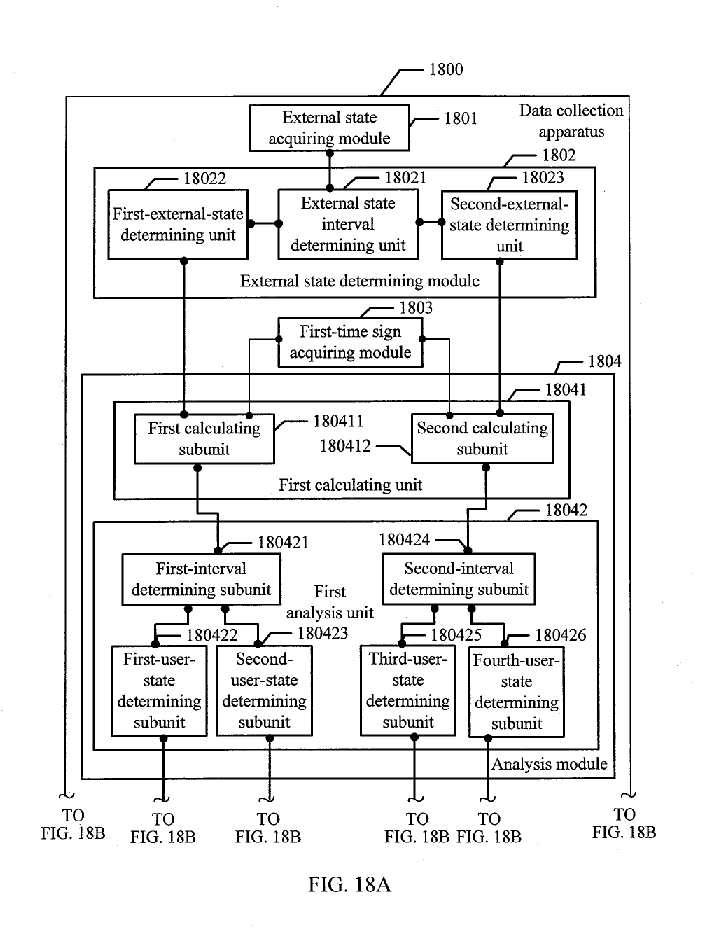

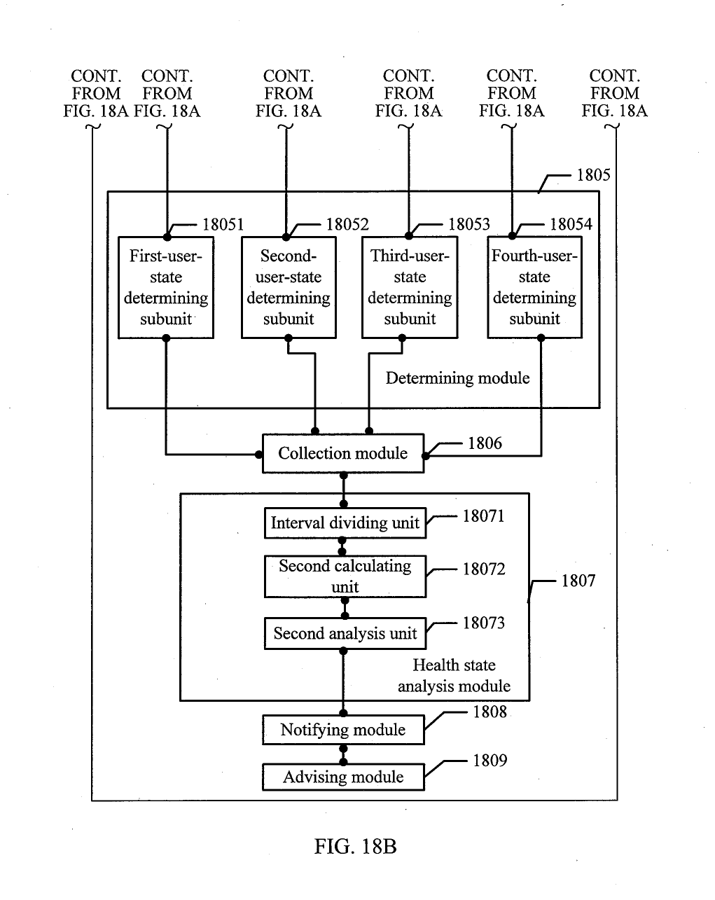

In the foregoing embodiment, the health state analysis module 1707 may first obtain a second deviation parameter by means of calculation according to second vital sign data, and then find a user health interval corresponding to the second deviation parameter, so as to obtain a user health state by means of analysis. The following describes a data collection apparatus in the embodiments of the present invention in detail. Referring to FIG. 18A and FIG. 18B, another embodiment of a data collection apparatus 1800 in the embodiments of the present invention includes:

an external state acquiring module 1801, configured to acquire external state data;

an external state determining module 1802, configured to determine an external state according to the external state data acquired by the external state acquiring module 1801;

a first-time sign acquiring module 1803, configured to acquire first vital sign data;

an analysis module 1804, configured to analyze a user state according to the external state determined by the external state determining module 1802 and the first vital sign data acquired by the first-time sign acquiring module 1803;

a determining module 1805, configured to determine collection frequency according to the user state obtained by means of analysis by the analysis module 1804; and

a collection module 1806, configured to collect second vital sign data at the collection frequency determined by the determining module 1805.

The external state determining module 1802 specifically includes:

an external state interval determining unit 18021, configured to determine an external state interval to which the external state data acquired by the external state acquiring module 1801 belongs;

a first-external-state determining unit 18022, configured to: when the external state interval determining unit 18021 determines that the external state data belongs to a first external state interval, determine that the external state is a first external state; and

a second-external-state determining unit 18023, configured to: when the external state interval determining unit 18021 determines that the external state data belongs to a second external state interval, determine that the external state is a second external state.

The analysis module 1804 specifically includes:

a first calculating unit 18041, configured to obtain a first deviation parameter by means of calculation according to the external state determined by the external state determining module 1802 and the first vital sign data acquired by the first-time sign acquiring module 1803; and

a first analysis unit 18042, configured to analyze the user state according to the first deviation parameter obtained by means of calculation by the first calculating unit 18041 and the external state determined by the external state determining module 1802.

The first calculating unit 18041 specifically includes:

a first calculating subunit 180411, configured to: when the external state determined by the external state determining module 1802 is the first external state, acquire a first normal sign range in the first external state, and obtain a first deviation parameter in the first external state by means of calculation according to the first normal sign range and the first vital sign data that is acquired by the first-time sign acquiring module 1803; and

a second calculating subunit 180412, configured to: when the external state determined by the external state determining module 1802 is the second external state, acquire a second normal sign range in the second external state, and obtain a first deviation parameter in the second external state by means of calculation according to the second normal sign range and the first vital sign data that is acquired by the first-time sign acquiring module 1803.

The first analysis module 18042 specifically includes:

a first-interval determining subunit 180421, configured to: when the external state determined by the external state determining module 1802 is the first external state, determine a user state interval corresponding to the first deviation parameter that is in the first external state and obtained by means of calculation by the first calculating subunit 180411;

a first-user-state determining subunit 180422, configured to: when the first deviation parameter that is in the first external state and obtained by means of calculation by the first calculating subunit 180411 belongs to a first user state interval, determine that the user state is a first user state;

a second-user-state determining subunit 180423, configured to: when the first deviation parameter that is in the first external state and obtained by means of calculation by the first calculating subunit 180411 belongs to a second user state interval, determine that the user state is a second user state, where a value of a first deviation parameter in the first user state interval is less than or equal to a value of a first deviation parameter in the second user state interval;

a second-interval determining subunit 180424, configured to: when the external state determined by the external state determining module 1802 is the second external state, determine a user state interval corresponding to the first deviation parameter that is in the second external state and obtained by means of calculation by the second calculating subunit 180412;

a third-user-state determining subunit 180425, configured to: when the first deviation parameter that is in the second external state and obtained by means of calculation by the second calculating subunit 180412 belongs to a third user state interval, determine that the user state is a third user state; and

a fourth-user-state determining subunit 180426, configured to: when the first deviation parameter that is in the second external state and obtained by means of calculation by the second calculating subunit 180412 belongs to a fourth user state interval, determine that the user state is a fourth user state, where a value of a first deviation parameter in the third user state interval is less than or equal to a value of a first deviation parameter in the fourth user state interval.

The determining module 1805 specifically includes:

a first-frequency determining unit 18051, configured to: when the user state determined by the first-user-state determining subunit 180422 is the first user state, determine that the collection frequency is first collection frequency;

a second-frequency determining unit 18052, configured to: when the user state determined by the second-user-state determining subunit 180423 is the second user state, determine that the collection frequency is second collection frequency, where the first collection frequency is less than the second collection frequency;

a third-frequency determining unit 18053, configured to: when the user state determined by the third-user-state determining subunit 180425 is the third user state, determine that the collection frequency is third collection frequency; and

a fourth-frequency determining unit 18054, configured to: when the user state determined by the fourth-user-state determining subunit 180426 is the fourth user state, determine that the collection frequency is fourth collection frequency, where the third collection frequency is less than the fourth collection frequency.

The data collection apparatus further includes:

a health state analysis module 1807, configured to obtain a user health state by means of analysis according to the second vital sign data collected by the collection module 1806;

a notifying module 1808, configured to notify a user when the user health state obtained by means of analysis by the health state analysis module 1807 reaches a preset state; and

an advising module 1809, configured to provide the user with health advice according to the user health state obtained by means of analysis by the health state analysis module 1807.

In this embodiment, the health state analysis module 1807 specifically includes:

an interval dividing unit 18071, configured to divide a user health state into N health state intervals according to a preset value range of a second deviation parameter, where N is a positive integer;

a second calculating unit 18072, configured to obtain a second deviation parameter by means of calculation according to the second vital sign data collected by the collection module 1806; and

a second analysis unit 18073, configured to obtain the user health state by means of analysis according to the health state intervals obtained by means of division by the interval dividing unit 18071 and the second deviation parameter obtained by means of calculation by the second calculating unit 18072.

In this embodiment of the present invention, an interval dividing unit 18071 divides a user health state into N health state intervals according to a preset value range of a second deviation parameter; and after a collection module 1806 collects second vital sign data, a second calculating unit 18072 obtains a second deviation parameter by means of calculation, and a second analysis unit 18073 obtains a user health state by searching for a health state interval corresponding to the second deviation parameter. In this way, user health state analysis is more standard and accurate.

For ease of understanding the foregoing embodiment, the following describes an interaction process of all units of the foregoing data collection apparatus by using a specific application scenario:

A user activates a pulse monitoring and situation awareness function of the data collection apparatus by using a physical switch, and the data collection apparatus reminds the user to confirm user information;

the first-time sign acquiring module 1803 acquires first-time pulse data of the user; a temperature and humidity sensor in the external state acquiring module 1801 acquires temperature and humidity in an environment; a barometric pressure sensor acquires an altitude; a sound sensor acquires noise intensity; an acceleration sensor acquires an acceleration parameter; a gyroscope acquires a orientation parameter; and a timer records activity time;

according to environmental state data and activity state data that are obtained by means of measurement, the external state determining module 1802 determines that the user runs for more than 30 minutes and swims for more than 20 minutes, so that the external state determining module 1802 determines that the user is in a strenuous activity state;

the first calculating unit 18041 acquires a normal sign range of healthy people in the strenuous activity state;

the first calculating subunit 180411 obtains, by means of calculation according to the first-time pulse data and the normal sign range of healthy people that are in the strenuous activity state, that a pulse deviation percentage in the strenuous activity state is 20%, and a calculation formula is as follows:

$$Pulse de viation percentage \% = \vert ( \frac{2 \times {pulse}_{first \text{-} time} - ( 108 + 134 )}{134 - 108} ) \times 100 \% \vert$$

the first-interval determining subunit 180421 determines a user state interval corresponding to the pulse deviation percentage 20%;

the first-user-state determining subunit 180422 determines that a user state corresponding to the user state interval is good;

the first-frequency determining subunit 18051 determines that a collection period for the user state “good” in the strenuous activity state is 10 minutes;

the collection module 1806 collects pulse data of the user in a period of 10 minutes;

the second calculating unit 18072 obtains, by means of calculation according to the collected pulse data, that the pulse deviation percentage is 18%;

the second analysis unit 18073 determines that a user health state interval corresponding to 18% is a excellent health state;

the notifying module 1808 plays the user health state for the user in an audio manner;

the user selects to view health states within two weeks, and the second analysis unit 18073 calculates an average value of second deviation parameters within the two weeks, so as to obtain that a user health state corresponding to the average value is a medium health state; and

the advising module 1809 provides the user with health advice according to the medium health state.

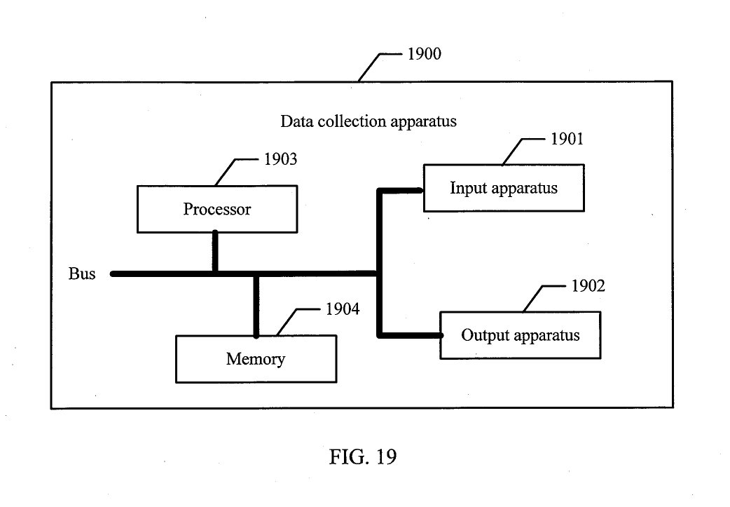

The foregoing describes the data collection apparatus in the embodiments of the present invention from a perspective of unitization of a functional entity; and the following describes the data collection apparatus in the embodiments of the present invention from a perspective of hardware processing. Referring to FIG. 19, another embodiment of a data collection apparatus 1900 in the embodiments of the present invention includes:

an input apparatus 1901, an output apparatus 1902, a processor 1903, and a memory 1904 (there may be one or more processors 1903 in the data collection apparatus 1900, and that there is one processor 903 is used as an example in FIG. 19).

In some embodiments of the present invention, the input apparatus 1901, the output apparatus 1902, the processor 1903, and the memory 1904 may be connected to each other by using a bus or connected in another manner. That they are connected to each other by using a bus is used as an example in FIG. 19.

By invoking an operation instruction stored in the memory 1904, the processor 1903 is configured to perform the following steps:

acquiring first vital sign data;

analyzing a user state according to the first vital sign data;

determining collection frequency according to the user state; and

collecting second vital sign data at the collection frequency.

In some embodiments of the present invention, the processor 1903 specifically performs the following steps:

obtaining a first deviation parameter by means of calculation according to the first vital sign data; and

analyzing the user state according to the first deviation parameter.

In some embodiments of the present invention, the processor 1903 specifically performs the following steps:

determining a user state interval corresponding to the first deviation parameter;

when the first deviation parameter belongs to a first user state interval, determining that the user state is a first user state; and

when the first deviation parameter belongs to a second user state interval, determining that the user state is a second user state, where a value of a first deviation parameter in the first user state interval is less than or equal to a value of a first deviation parameter in the second user state interval.

In some embodiments of the present invention, the processor 1903 specifically performs the following steps:

when the user state is the first user state, determining that the collection frequency is first collection frequency; and

when the user state is the second user state, determining that the collection frequency is second collection frequency, where the first collection frequency is less than the second collection frequency.

In some embodiments of the present invention, the processor 1903 further performs the following steps:

dividing a user health state into N health state intervals according to a preset value range of a second deviation parameter, where N is a positive integer;

obtaining a second deviation parameter by means of calculation according to the second vital sign data;

obtaining the user health state by means of analysis according to the health state intervals and the second deviation parameter;

notifying a user when the user health state reaches a preset state; and

providing the user with health advice according to the user health state.

In some embodiments of the present invention, the processor 1903 further performs the following steps:

acquiring external state data; and

determining an external state according to the external state data.

In some embodiments of the present invention, the processor 1903 specifically performs the following steps:

determining an external state interval to which the external state data belongs;

when the external state data belongs to a first external state interval, determining that the external state is a first external state;

when the external state data belongs to a second external state interval, determining that the external state is a second external state;

obtaining a first deviation parameter by calculation according to the external state and the first vital sign data; and

analyzing the user state according to the first deviation parameter and the external state.

In some embodiments of the present invention, the processor 1903 specifically performs the following steps:

when the external state is the first external state, acquiring a first normal sign range in the first external state, and obtaining a first deviation parameter in the first external state by calculation according to the first normal sign range and the first vital sign data;

when the external state is the second external state, acquiring a second normal sign range in the second external state, and obtaining a first deviation parameter in the second external state by calculation according to the second normal sign range and the first vital sign data;

when the external state is the first external state, determining a user state interval corresponding to the first deviation parameter in the first external state;

when the first deviation parameter in the first external state belongs to a first user state interval, determining that the user state is a first user state;

when the first deviation parameter in the first external state belongs to a second user state interval, determining that the user state is a second user state, where a value of a first deviation parameter in the first user state interval is less than or equal to a value of a first deviation parameter in the second user state interval;

when the external state is the second external state, determining a user state interval corresponding to the first deviation parameter in the second external state;

when the first deviation parameter in the second external state belongs to a third user state interval, determining that the user state is a third user state;

when the first deviation parameter in the second external state belongs to a fourth user state interval, determining that the user state is a fourth user state, where a value of a first deviation parameter in the third user state interval is less than or equal to a value of a first deviation parameter in the fourth user state interval;

when the user state is the first user state, determining that the collection frequency is first collection frequency;

when the user state is the second user state, determining that the collection frequency is second collection frequency, where the first collection frequency is less than the second collection frequency;

when the user state is the third user state, determining that the collection frequency is third collection frequency; and

when the user state is the fourth user state, determining that the collection frequency is fourth collection frequency, where the third collection frequency is less than the fourth collection frequency.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The foregoing integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present invention essentially, or the part contributing to the prior art, or all or a part of the technical solutions may be implemented in a form of a software product. The software product is stored in a storage medium and includes several instructions for instructing a computer device (which may be a personal computer, a server, or a network device) to perform all or a part of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof; however, these modifications or replacements do not make the essence of corresponding technical solutions depart from the spirit and scope of the technical solutions in the embodiments of the present invention.

What is claimed is:

1. A data collection method, comprising:
acquiring, by a data collection apparatus, first vital sign data;
analyzing, by the data collection apparatus, a user state according to the first vital sign data;
determining, by the data collection apparatus, collection frequency according to the user state; and
collecting, by the data collection apparatus, second vital sign data at the collection frequency.

2. The method according to claim 1, wherein:
acquiring, by a data collection apparatus, first vital sign data comprises:
acquiring, by the data collection apparatus, the first vital sign data by using a medical sensor in the data collection apparatus; and
analyzing, by the data collection apparatus, a user state according to the first vital sign data comprises:
obtaining, by the data collection apparatus, a first deviation parameter by calculation according to the first vital sign data, and
analyzing, by the data collection apparatus, the user state according to the first deviation parameter.

3. The method according to claim 2, wherein analyzing, by the data collection apparatus, the user state according to the first deviation parameter comprises:
determining, by the data collection apparatus, a user state interval corresponding to the first deviation parameter;
if the first deviation parameter belongs to a first user state interval, determining that the user state is a first user state; and
if the first deviation parameter belongs to a second user state interval, determining that the user state is a second user state, wherein a value of a first deviation parameter in the first user state interval is less than or equal to a value of a first deviation parameter in the second user state interval.

4. The method according to claim 3, wherein determining, by the data collection apparatus, collection frequency according to the user state comprises:
if the user state is the first user state, determining, by the data collection apparatus, that the collection frequency is first collection frequency; and
if the user state is the second user state, determining, by the data collection apparatus, that the collection frequency is second collection frequency, wherein the first collection frequency is less than the second collection frequency.

5. The method according to claim 2 wherein acquiring, by the data collection apparatus, the first vital sign data by using a medical sensor in the data collection apparatus comprises:
acquiring, by the data collection apparatus, a shell temperature parameter of a user by using a temperature sensor in the medical sensor; or
acquiring, by the data collection apparatus, a pulse parameter of a user by using a vibration sensor in the medical sensor; or
acquiring, by the data collection apparatus, a blood pressure parameter of a user by using a pressure sensor in the medical sensor; or
acquiring, by the data collection apparatus, a respiration parameter of a user by using a air flow sensor in the medical sensor; or
acquiring, by the data collection apparatus, a blood glucose parameter of a user by using a heat flux sensor in the medical sensor; or
acquiring, by the data collection apparatus, an emotion parameter of a user by using a bioelectrical sensor in the medical sensor.

6. The method according to claim 5, further comprising:
obtaining, by the data collection apparatus, a user health state by means of analysis according to the second vital sign data.

7. The method according to claim 6, wherein obtaining, by the data collection apparatus, a user health state by means of analysis according to the second vital sign data comprises:
dividing, by the data collection apparatus, a user health state into N health state intervals according to a preset value range of a second deviation parameter, wherein N is a positive integer;
obtaining, by the data collection apparatus, a second deviation parameter by means of calculation according to the second vital sign data; and
obtaining, by the data collection apparatus, the user health state by means of analysis according to the health state intervals and the second deviation parameter.

8. The method according to claim 7, wherein the user health state comprises:
a real-time user health state or a statistical user health state, wherein the statistical user health state is used to indicate a statistical average value of second deviation parameters that are corresponding to real-time user health states within a preset time.

9. A data collection apparatus, comprising:
an acquiring module, configured to acquire first vital sign data;
an analysis module, configured to analyze a user state according to the first vital sign data acquired by the acquiring module;
a determining module, configured to determine collection frequency according to the user state obtained by means of analysis by the analysis module; and
a collection module, configured to collect second vital sign data at the collection frequency determined by the determining module.

10. The apparatus according to claim 9, wherein:
the acquiring module is a medical sensor; and
the analysis module comprises:
a first calculating unit, configured to obtain a first deviation parameter by means of calculation according to the first vital sign data acquired by the acquiring module, and
a first analysis unit, configured to analyze the user state according to the first deviation parameter obtained by means of calculation by the first calculating unit.

11. The apparatus according to claim 10, wherein the first analysis unit comprises:
an interval determining subunit, configured to determine a user state interval corresponding to the first deviation parameter obtained by means of calculation by the first calculating unit;
a first-state determining subunit, configured to: when the first deviation parameter obtained by means of calculation by the first calculating unit belongs to a first user state interval, determine that the user state is a first user state; and
a second-state determining subunit, configured to: when the first deviation parameter obtained by means of calculation by the first calculating unit belongs to a second user state interval, determine that the user state is a second user state, wherein a value of a first deviation parameter in the first user state interval is less than or equal to a value of a first deviation parameter in the second user state interval.

12. The apparatus according to claim 11, wherein the determining module comprises:
a first-frequency determining unit, configured to: when the first-state determining subunit determines that the user state is the first user state, determine that the collection frequency is first collection frequency; and
a second-frequency determining unit, configured to: when the second-state determining subunit determines that the user state is the second user state, determine that the collection frequency is second collection frequency, wherein the first collection frequency is less than the second collection frequency.

13. The apparatus according to claim 10, wherein the medical sensor comprises:
a temperature sensor, configured to acquire a shell temperature parameter of a user; or
a vibration sensor, configured to acquire a pulse parameter of a user; or
a pressure sensor, configured to acquire a blood pressure parameter of a user; or
a flow sensor, configured to acquire a respiration parameter of a user; or
a heat flux sensor, configured to acquire a blood glucose parameter of a user; or
a bioelectrical sensor, configured to acquire an emotion parameter of a user.

14. The apparatus according to claim 13, further comprising:
a health state analysis module, configured to obtain a user health state by means of analysis according to the second vital sign data collected by the collection module.

15. The apparatus according to claim 14, wherein the health state analysis module comprises:
an interval dividing unit, configured to divide a user health state into N health state intervals according to a preset value range of a second deviation parameter, wherein N is a positive integer;
a second calculating unit, configured to obtain a second deviation parameter by means of calculation according to the second vital sign data collected by the collection module; and
a second analysis unit, configured to obtain the user health state by means of analysis according to the health state intervals obtained by means of division by the interval dividing unit and the second deviation parameter obtained by means of calculation by the second calculating unit.

16. A data collection apparatus, comprising:
an input apparatus, an output apparatus, a processor, and a memory, wherein:
by invoking operation instructions stored in the memory, the processor is configured to perform the following:
acquiring first vital sign data;
analyzing a user state according to the first vital sign data;
determining collection frequency according to the user state; and
collecting second vital sign data at the collection frequency.

17. The collection apparatus according to claim 16, wherein the processor is configured to perform the following:
obtaining a first deviation parameter by means of calculation according to the first vital sign data; and
analyzing the user state according to the first deviation parameter.

18. The collection apparatus according to claim 17, wherein the processor is configured to perform the following:
determining a user state interval corresponding to the first deviation parameter;
when the first deviation parameter belongs to a first user state interval, determining that the user state is a first user state; and
when the first deviation parameter belongs to a second user state interval, determining that the user state is a second user state, wherein a value of a first deviation parameter in the first user state interval is less than or equal to a value of a first deviation parameter in the second user state interval.

19. The collection apparatus according to claim 18, wherein the processor is configured to perform the following:
when the user state is the first user state, determining that the collection frequency is first collection frequency; and
when the user state is the second user state, determining that the collection frequency is second collection frequency, wherein the first collection frequency is less than the second collection frequency.

20. The collection apparatus according to claim 19, wherein the processor is configured to perform the following:
dividing a user health state into N health state intervals according to a preset value range of a second deviation parameter, wherein N is a positive integer;
obtaining a second deviation parameter by means of calculation according to the second vital sign data;
obtaining the user health state by means of analysis according to the health state intervals and the second deviation parameter;
notifying a user when the user health state reaches a preset state; and
providing the user with health advice according to the user health state.

21. The collection apparatus according to claim 16, wherein the processor is further configured to perform the following:
acquiring external state data; and
determining an external state according to the external state data.

22. The collection apparatus according to claim 21, wherein the processor is configured to perform the following:
determining an external state interval to which the external state data belongs;
when the external state data belongs to a first external state interval, determining that the external state is a first external state;
when the external state data belongs to a second external state interval, determining that the external state is a second external state;
obtaining a first deviation parameter by means of calculation according to the external state and the first vital sign data; and
analyzing the user state according to the first deviation parameter and the external state.

23. The collection apparatus according to claim 22, wherein the processor is configured to perform the following:
when the external state is the first external state, acquiring a first normal sign range in the first external state, and obtaining a first deviation parameter in the first external state by means of calculation according to the first normal sign range and the first vital sign data;
when the external state is the second external state, acquiring a second normal sign range in the second external state, and obtaining a first deviation parameter in the second external state by means of calculation according to the second normal sign range and the first vital sign data;
when the external state is the first external state, determining a user state interval corresponding to the first deviation parameter in the first external state;
when the first deviation parameter in the first external state belongs to a first user state interval, determining that the user state is a first user state;
when the first deviation parameter in the first external state belongs to a second user state interval, determining that the user state is a second user state, wherein a value of a first deviation parameter in the first user state interval is less than or equal to a value of a first deviation parameter in the second user state interval;
when the external state is the second external state, determining a user state interval corresponding to the first deviation parameter in the second external state;
when the first deviation parameter in the second external state belongs to a third user state interval, determining that the user state is a third user state;
when the first deviation parameter in the second external state belongs to a fourth user state interval, determining that the user state is a fourth user state, wherein a value of a first deviation parameter in the third user state interval is less than or equal to a value of a first deviation parameter in the fourth user state interval;
when the user state is the first user state, determining that the collection frequency is first collection frequency;
when the user state is the second user state, determining that the collection frequency is second collection frequency, wherein the first collection frequency is less than the second collection frequency;
when the user state is the third user state, determining that the collection frequency is third collection frequency; and
when the user state is the fourth user state, determining that the collection frequency is fourth collection frequency, wherein the third collection frequency is less than the fourth collection frequency.
